(19) United States
(12) Patent Application Publication
(10) Pub. No.: US 2003/0009437 A1
(43) Pub. Date: Jan. 9, 2003

(54) Method and system for information communication between potential positionees and positionors

(76) Inventors: Margaret Seiler, Dekalb, IL (US); Thomas Revane, Elmhurst, IL (US); Daniel Ambrecht, Crestwood, IL (US); William Backs, Evanston, IL (US); William Bailey, Evanston, IL (US); Andrew Bennett, Wheaton, IL (US); Larry Books, Mt. Vernon, IL (US); James Bremenkamp, Chicago, IL (US); Brad Brown, Chicao, IL (US); Rodger Campbell, Chicago, IL (US); Ten-Hung Chu, Hoffman Estates, IL (US); Michael Cooney, Lake Zurich, IL (US); Mitchell Daniels, Buffalo, IL (US); Rory Dickinson, Arlington Heights, IL (US); Martin Donnelly, Elmhurst, IL (US); Ann Fish, Chicago, IL (US); Sandra Gates, Maywood, IL (US); Sandra Grepling, Villa Park, IL (US); Michael Gulino, Oak Lawn, IL (US); William Harrison, Gary, IN (US); Steven Holman, Chicago, IL (US); Douglas Horton, Lansing, IL (US); Raymond Jackson, University PK, IL (US); Simon Jin, Chicago, IL (US); Christopher Jones, Elmwood Park, IL (US); Gunter Kalogridis, Chicago, IL (US); Paul Kreiner, St. Charles, IL (US); Breck Kuhnke, Chicago, IL (US); Louis Lembcke, La Grange, IL (US); Timothy Lenning, Naperville, IL (US); Thomas Lepore, Elmhurst, IL (US); Gary Mayer, Buffalo Grove, IL (US); Joseph Mindock, Oswego, IL (US); Karl Moulton, Peoria, IL (US); Brent Peebles, Chicago, IL (US); Denise Pike, Naperville, IL (US); Andrzej Placzek, Chicago, IL (US); Timoty Saar, Franklin Park, IL (US); Mark Schlosser, Chicago, IL (US); Susan Schumerth, Chicago, IL (US); Scott Sellers, Chicago, IL (US); Andrew Sutter, Woodstock, IL (US); Korol Taylor, Evanston, IL (US); Eric Toennies, Naperville, IL (US); William Vonderhaar, Chicago, IL (US); M. John Way, Wheaton, IL (US); Lisa Winfrey, Joliet, IL (US); Carol Yanowitz, Chicago, IL (US); Youan Zeng, Des Plaines, IL (US); Mark Zgarrick, Evanston, IL (US); Saptarshi Kateata, Elk Grove Village, IL (US); Angel Li, Chicago, IL (US)

Correspondence Address: Wallenstein & Wagner, Ltd., 53rd Floor, 311 S. Wacker Drive, Chicago, IL, 60606-6630, US

(21) Appl. No.: 09/919,594

(22) Filed: Jul. 31, 2001

Related U.S. Application Data
(60) Provisional application No. 60/222,689, filed on Aug. 2, 2000.

(51) Int. Cl. G06F 7/00

(52) U.S. Cl. 707/1

(57) ABSTRACT

A computer program and method are disclosed for matching a potential positionee and potential positionor. The potential positionee is provided with a positionee information entry interface for entering positionee information comprising the potential positionee's actual qualifications. The positionee information is stored in a database. Matching is accomplished by providing the potential positionor with a positionor information entry interface for electronically entering positionor information comprising at least one target qualification for a position, the positionor information being stored in the database. Matching is based on determining whether the positionee information correlates with the positionor information. A correlated information list is created. The correlated information is presented for review. Code sections of the computer program preferably accomplish these and other tasks.

### BACKGROUND OF THE INVENTION

One objective of job placement services is to be a tool for employers to utilize in finding qualified job applicants or job seekers. Employment services are now available online, such as on the Internet, and have become a key component of job searching, placement, and for assisting employers to find job seekers.

Current job placement online systems are not sufficiently user-friendly, do not contain the necessary flexibility needed to track skills, and do not manage employer data. Also, current systems do not sufficiently track other employee data, or the interaction between job seekers and potential employers. One such current system is U.S. Pat. No. 5,832,497, currently implemented at http://www.monster.com on the Internet. Another such current system is located at http://www.ohioworks.com on the Internet. The present invention is provided to solve these and other problems.

### SUMMARY OF THE INVENTION

According to a broad aspect of a preferred embodiment of the invention, a method of matching a potential positionee and a potential positionor by providing the potential positionee with a positionee information entry interface for electronically entering positionee information comprising the potential positionee's actual qualifications, the positionee information being stored in a database is provided. Matching is further accomplished by providing the potential positionor with a positionor information entry interface for electronically entering positionor information comprising at least one target qualification for a position, the positionor information being stored in the database. Matching is based on determining whether the positionee information correlates with the positionor information. The method then provides for the creating of a correlated information list of correlated information and presenting the correlated information for review.

The positionee information may be maintained as confidential and may also include contact information for receiving communication, veteran information, transportation information for position site availability, work history information, and education information. In addition, the positionee information may also include at least one position category and actual qualifications of at least one skill relating to the position category. The qualifications are selected from a positionee skills listing. Positionor information also includes positionor entity information. The method also verifies the existence of the potential positionor using the positionor entity information.

Positionor information may include positionor contact information, as well as a plurality of target qualifications for the position, salary information required for the position, benefits information for the position, site location information for the position, special programs participation information, and a position category. The position category contains at least one skill required for the position. The position category may also include at least one skill that would be nice to have, but that is not required.

The target qualifications reflect at least one skill selected from a positionor skills listing and may include at least one skill selected from a positionee skills listing. The target qualifications are useful in determining whether the positionee information correlates with the positionor information. The resulting correlated information contains only potential positionees or potential positionors for which a correlation has taken place. Positionees and/or positionors may select one or more skills from a skills listing to identify actual qualifications or target qualifications. Particular skills can be added and/or deleted to/from the skills listing. Furthermore, the positionee information and/or the positionor information can be edited, and if editing occurs correlation is determined again.

The correlated information is rank-ordered according to one or more of the following ranking criteria: skills that would be nice to have, but not required for the position; special programs information; and, veteran information. The correlated information list may be used as a trial correlated information list including only the number of correlated potential positionees for a potenial positionor, without an identification of the potential positionees. Then an order for a position may be submitted.

The correlated information list includes a list of correlated potential positionors for consideration by one of the potential positionees, and a list of correlated potential positionees for consideration by one of the potential positionors. The potential positionee can choose to be removed from the correlated information list from which the potential positionor considers such potential positionee.

At least one step is performed over a computer network, such as a LAN or the Internet. The positionee and positionor information can be inputted over a computer network, such as a LAN or the Internet. The correlated information may also provided over a computer network, such as a LAN or the Internet via e-mail, phone, fax, or letter.

The method of matching also uses a preexisting selection hierarchy with the steps of selecting a position from a preexisting set of positions; and selecting a skill from a preexisting set of skills relating to the selected position. The preexisting set of positions relate to the selected field from the preexisting set of fields. In addition, the preexisting selection hierarchy includes preexisting sets of positions, with each preexisting set of positions relating to one field within the preexisting set of fields. The preexisting selection hierarchy may also include preexisting sets of skills, with each preexisting set of skills relating to one position within the preexisting set of positions. A skill may also be displayed under multiple preexisting sets of positions in order to facilitate matching across job titles or job categories. Fields, skills, and positions can be added or deleted. Additionally, the preexisting selection hierarchy is stored in electronically readable memory.

A computer program for matching a potential positionee and a potential positionor is also provided. The computer program includes a code segment providing the potential positionee with a positionee information entry interface for electronically entering positionee information comprising the potential positionee's actual qualifications, the positionee information being stored in a database; a code segment providing the potential positionor with a positionor information entry interface for electronically entering positionor information comprising at least one target qualification for a position, the positionor information being stored in the database; a code segment for determining whether the positionee information correlates with the positionor information; a code segment creating a correlated information list of correlated information; and a code segment providing the correlated information for review.

The method further provides for participation in assisted position placement within special programs. The potential positionee utilizes a positionee information entry interface for electronically entering positionee information for determining whether the potential positionee qualifies for a special program. The positionee information is then stored in a database. In addition, the potential positionor utilizes a positionor information entry interface for electronically entering positionor information to determine whether the potential positionor is participating in one or more special programs, including: DOC 7-B; MANG; TANF; WOTC; HTF; NAFS; Title I; International Registry: Sr. Comm. Service Employment Program; and Title II. The positionor information is then stored in the database as well. The method further determines whether the positionee information correlates with the positionor information, thereby creating a correlated information list of correlated information. This correlated information list provides the correlated information for review.

### BRIEF DESCRIPTION OF THE FIGURES

FIG. 1 is an overview of the system

FIG. 2 is a web page illustration of job seeker registration

FIG. 3 is a diagram representing skill selection for a job seeker

FIG. 4 is a web page illustration of employer registration

FIG. 5 is a representation of the general organization of web pages to provide a customized menu of function options

FIG. 6 is an illustration of the general layout of a typical web page of the system

FIG. 7 is a web page illustration of the home/login page

FIG. 8 is a web page illustration of the job seeker menu page

FIG. 9 is a web page illustration of the employer menu page

FIG. 10 is a web page illustration of the staff menu page

FIG. 11 is a web page illustration of the job seeker search page

FIG. 12 is a web page illustration of a list page

FIG. 13 is a web page illustration of a detail page

FIG. 14 is a web page illustration of a job seeker registration page

FIG. 15 is a web page illustration of the forms for job seeker registration

FIG. 16 is a web page illustration of the veteran information

FIG. 17 is a web page illustration of the transportation form and work information form

FIG. 18 is a web page illustration of the optional forms for work history

FIG. 19 is a web page illustration of the optional forms for education

FIG. 20 is a web page illustration of a job position

FIG. 21 is a web page illustration of a skills checklist

FIG. 22 is a web page illustration of the employer login

FIG. 23 is a web page illustration of the company information and contact information forms

FIG. 24 is a web page illustration of a job order worksheet

FIG. 25 is a web page illustration of a worksite information form

FIG. 26 is a web page illustration of the ability to hide/reveal employer contact information

FIG. 27 is an example of a web page illustration of skills for a job order

FIG. 28 is an example of web page illustration of the experience level for skills

FIG. 29 is a web page illustration of a qualified candidate list

FIG. 30 is an example of a web page illustration of recruiting actions

FIG. 31 is a web page illustration of a staff menu

FIG. 32 is a web page illustration of a special programs page

FIG. 33 is an example of a web page illustration of a staff search screen

FIG. 34 is an example of a web page illustration of a staff search screen for job seekers

FIG. 35 is an example of a web page illustration of a staff edit screen for editing employer company information and employer contact information

FIG. 36 is an example of a web page illustration of a staff edit screen for editing transportation information and work information

FIG. 37 is an example of a web page illustration of rank-ordering of matches

FIG. 38 is an illustration of the invention's multi-tier technical architecture

FIG. 39 illustrates the integration of components in the potential positionee/positionor system

FIG. 40 shows transaction flow in the potential positionee/positionor system

FIG. 41 illustrates how the HTTP Router interacts with other components within the potential positionee/positionor technical environment

FIG. 42 illustrates the flow of information between the web servers and application servers

FIG. 43 illustrates the interaction between the application servers and the other system components

FIG. 44 illustrates the interaction between the database servers and the other system components

FIG. 45 illustrates the major components involved in a highly available database design

FIG. 46 illustrates the major components required to achieve parallelism in a database design

FIG. 47 illustrates interaction between the three “subnetworks” of the invention's network environment

FIG. 48 is a diagram of the web servers and the components they communicate with

FIG. 49 shows the application servers' architecture and interconnection to other components

FIG. 50 illustrates the use of a database cluster

FIG. 51 summarizes the Sun Cluster, mirrored disks, and DB2 UDB EEE's interaction with these components

FIG. 52 illustrates at a high-level how the Servlets, JSPs and Extensions work within a iAS server and the points of interaction with the web server, database servers, and other external services

FIG. 53 illustrates the tiers of a web application and which iAS and other components address which tier

FIG. 54 shows the flow of a iAS based application

FIG. 55 illustrates the division of the network architecture into zones where traffic flow can be denied for security purposes

FIG. 56 is a more specific diagram of the zone division for security purposes

FIG. 57 is a diagram of the potential positionee/positionor's database design showing the top-left portion of an overall diagram

FIG. 58 is a continuation of the diagram of FIG. 57 showing the top-right portion of an overall diagram

FIG. 59 is a continuation of the diagram of FIG. 57 showing the bottom-left portion of an overall diagram

FIG. 60 is a continuation of the diagram of FIG. 57 showing the bottom-right portion of an overall diagram

### DETAILED DESCRIPTION

The potential positionee/positionor system of the present invention provides employers with the best qualified candidates available by matching the skills needed by the employers to the skills held by job seekers. The system delivers the following benefits:

Emphasizing customer choice and self-service options to employers and job-seekers;

Developing an employer database that can track job order activity, success rates, and employer preferences;

Providing a flexible skills repository that can grow and change with business needs;

Allowing access to the system through a network;

Opening the system to a broader field of job candidates that may not otherwise be included in the labor exchange; and

Enabling continuous improvement.

This potential positionee/positionor system provides the employment service organizations with a tool to improve customer service, raises the image of such organizations with the employer community and job seeker community, and leverages the organization's staff to provide specialized labor market services to employers and job seekers.

The potential positionee/positionor system provides a method for matching employer's job openings with job seekers based on matching of standardized skills. Employers enter job orders and describe the required skills for the position. Applicants record the skills acquired through their various experiences and employment situations. The potential positionee/positionor system determines which job seekers match with which job openings. Based on restrictions specified by either party, the potential positionee/positionor system can then notify the parties of matches.

Employers and job seekers may use the potential positionee/positionor system through a secure and robust self service application via a network such as the Internet using a standard interface—a standard web browser. The Employers and job seekers may also work directly with the staff of an organization, such as an employment placement firm or an employment security component of a state government.

Organizational staff may also access the staff related functions of the potential positionee/positionor system by using standard interfaces, such as web browsers accessing the potential positionee/positionor system directly from the organization's LAN/WAN or via the Internet.

The potential positionee/positionor system is a robust business application with several subsystems, a relational database, with high availability and performance requirements and interfaces to legacy applications. The potential positionee/positionor system is both a mission critical business application and also a self-service Internet application for employers and job seekers. In the present form of the invention, the potential positionee/positionor system must support the following users:

Employers;

Job Seekers; and

Employment Organization Staff.

The application and technical infrastructure architectures of the potential positionee/positionor system are highly scalable and able to accommodate dramatic increases in the transaction volume without requiring a re-design of the application. The technical infrastructure is able to scale both vertically (within a server by adding CPU, memory, disk, etc.) and horizontally (by adding additional servers).

The technical architecture is implemented using a multi-tiered architecture. As mentioned, user access to the system can be provided through standard web browsers running on a Windows™ based environment on a personal computer. Other platforms are possible, as one of ordinary skill would understand. External users can access the system via the Internet while internal users can access the system via a network. The web browsers communicate with a collection of web servers. These web servers can serve both static content such as static pages and images. Requests for dynamically generated pages can be forwarded to application servers. The dynamic content can be generated via programs elicited by the application servers. These programs can access and manipulate persistent data via a DB2 database on a separate server.

Some of the various application protocols which can be used for communication between the components of the potential positionee/positionor system include:

FTP (File Transfer Protocol)—A cross-platform protocol for transferring files to and from computers on the Internet.

HTTP (HyperText Transport Protocol)—An Internet protocol providing a means for Web clients and servers to communicate with one another, primarily through the exchange of requests from the client and responses from the server.

HTTPS (Secure HTTP)—This is a secure version of the HTTP protocol described above. It is implemented as HTTP within an SSL session.

HTML (HyperText Markup Language)—HTML is not a protocol. It is a markup language that describes the structure of a Web document's content plus some behavioral characteristics. All Web browsers are able to understand and interpret this standard language resulting in a cross-platform mechanism for transmitting formatted “screens” and forms. There are several versions of HTML in wide use—ranging from HTML v1.1 to v3.2. The differences in these version are in their support of advanced HTML tags and features including tables, forms, frames, style sheets, layers, font specification, and scripting languages.

NCP/KCP (Netscape/Kiva Communication Protocol)—This is a proprietary protocol used between iPlanet Application Servers to perform data synchronization, exchange performance information, and implement fail-over and load-balancing.

Net.Data—Used for transferring database data manipulation transaction between the Application servers and the database server.

SMTP (Simple Mail Transport Protocol)—A standard protocol used to send electronic mail messages.

SNMP (Simple Network Management Protocol)—A standard protocol used to monitor hosts, routers, and the networks to which they are attached.

SSL (Secure Sockets Layer)—A protocol used to conduct secure encrypted transmission sessions between clients and servers to ensure the privacy of the information in the transmissions as it travels through the network. The other application layer protocols can use SSL to allow an encrypted form of the application layer protocol. For example, the HTTPS protocol is HTTP transmissions within an SSL session.

TCP/IP (Transmission Control Protocol/Internet Protocol)—The standard transport level protocol suite that provides the reliable, full duplex, stream service on which many application protocols depend.

Telnet (terminal access)—The standard application protocol that provides remote login and terminal access to the servers from the network.

The entire potential positionee/positionor application can be run from a web browser. All web page content can be delivered to the web browsers by the two web servers. It should be understood that one, two, or more servers can be used to implement the present invention. Static (non-changing) content can be hosted and served directly by the web servers. In the case of requests for content to be generated dynamically, the web servers can pass the request through to the application servers and can pass the response back through to the web browsers.

Although the user interface of the potential positionee/positionor system can be through a web browser, the potential positionee/positionor system is a robust business application. The application logic is implemented on the application servers, and Database access requests can be initiated by the application servers.

In one form of the present invention, the database servers provide the functionality for the data access layer of the application. Batch processing application components are co-hosted with the database services on the same physical servers. The application servers and the batch processing modules are the “clients” to the database services. The batch processing modules exchange information with legacy mainframe applications via periodic interface exports and imports. For the database to be highly available, single points of failure must be reduced. This requires that there be at least two systems combined into a database “cluster”. A database cluster is a set of two or more servers that act in cooperation to process data requests. In addition to having two physical servers, there must be fault tolerance built into the disk subsystem. The database cluster is able to survive a disk failure. Connectivity between the cluster members is redundant to reduce the cluster communications path as a single point of failure.

The design for the potential positionee/positionor system may require the use of two physical servers for high availability. There are several ways of achieving parallelism in a database. In one form of the present invention, a parallel database is a group of two or more database servers dividing the work of presenting a single logical database to the client.

The entire network infrastructure for the potential positionee/positionor system can use the TCP/IP protocol. The potential positionee/positionor system users can access the system using a web browser utilizing the HTTP protocol. Internal communications between the servers is TCP/IP based. Administration and management can be performed via HTTP, TELNET, and SNMP.

In one form of the present invention, due to the extensive use of TCP/IP, the configuration of Netscape browsers is changed so that packets do not need to be converted between IP and IPX. The current IPX/IP gateway can be reconfigured to perform a web proxy function only. The proxy can provide access to the Internet. Packets addressed to the potential positionee/positionor system from the LAN or WAN will go directly to the LocalDirector and on to the potential positionee/positionor system web servers. This reconfiguration will increase performance, and eliminate a potential bottleneck and point of failure. In addition to potential positionee/positionor system access, Internet access performance will be improved by this reconfiguration.

In one form of the present invention, the web clients' access to the potential positionee/positionor system can be maintained by sending and receiving requests and results to a web server. All interactive screens are displayed by formatting an HTML page and delivering its content to the user's browser. The web server sends requests for dynamic content to a separate application server. This server accesses the database server to retrieve data, assembles an HTML response, and then delivers the page back to the web server. Batch interface programs execute on the database server to transfer data between the potential positionee/positionor system database and existing mainframe applications. The potential positionee/positionor system application of the present invention, can be broken down into five basic components; the Web site components; the Online application components; the Batch components; the Reporting components; and the Infrastructure Components.

Web site components—The potential positionee/positionor system of the present invention can be accessed by a web browser. All user interface can be handled through the web server by sending HTML to the client and responding to the client's HTTP requests. The web server can also hold static content such as image files. In addition to the web server, the application server can generate web content. The application server can merge data from the database with HTML to generate the final HTML stream that gets delivered to the client browser. This operation can be performed by a Java Server Page (JSP). A JSP is a HTML page with special Java programming logic embedded in it.

Online application components—The application logic of the present invention of the potential positionee/positionor system can be implemented using iPlanet Application Server (iAS). iAS Servlets implement the majority of the business logic. A servlet is a Java program that executes on the iAS server in the context of a user session. Every user of the potential positionee/positionor system will enter through a logon process. At the time of logon, the user session will be instantiated. From that point forward, each HTTP request from that user that goes to the application servers will execute in the context set up when that user logged on. The Servlet accepts data from the web page where the data was entered. Data validation and database processing is then performed. The process continues with the next JSP being called to present the next page. Another component of the application is stored procedures in the DB2 database server. On the client side, some application logic and special user interface presentation mechanics are handled by JavaScript.

Batch components—Some of the functions performed by the potential positionee/positionor system of the present invention can run at regular intervals and can be scheduled to run in batch mode. These functions are primarily in the area of interfaces to existing mainframe systems. The programs run on the database server. All batch jobs are Korn shell scripts. Inside the script is the execution of Korn shell commands, Perl Scripts, and COBOL programs, which often make use of stored procedures in the database.

Reporting components—Standard reports are available from the potential positionee/positionor system of the present invention. These are typically daily, weekly, and monthly reports that can be delivered either electronically or manually depending on the capabilities of the individual office. These reports can run in batch mode on the database server.

Infrastructure Components—Functions that are outside of the business logic category of the present invention, but that form a foundation for the inner workings of the system can be classified as infrastructure components. These functions can be responsible for activities such as implementing the security system, error reporting and recovery, and other basic capabilities in the application that can be shared amongst the other components. The infrastructure components for the potential positionee/positionor system can be implemented through the base object model in Java, and extension modules that enhance the capabilities of iAS and the base operating system.

Web Site Architecture

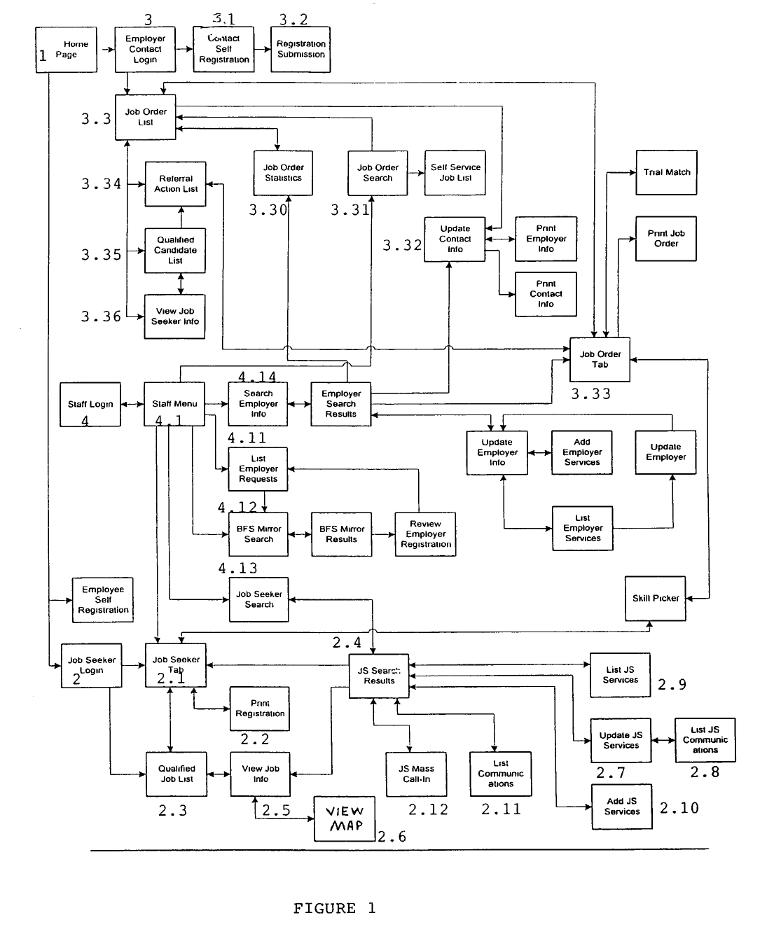

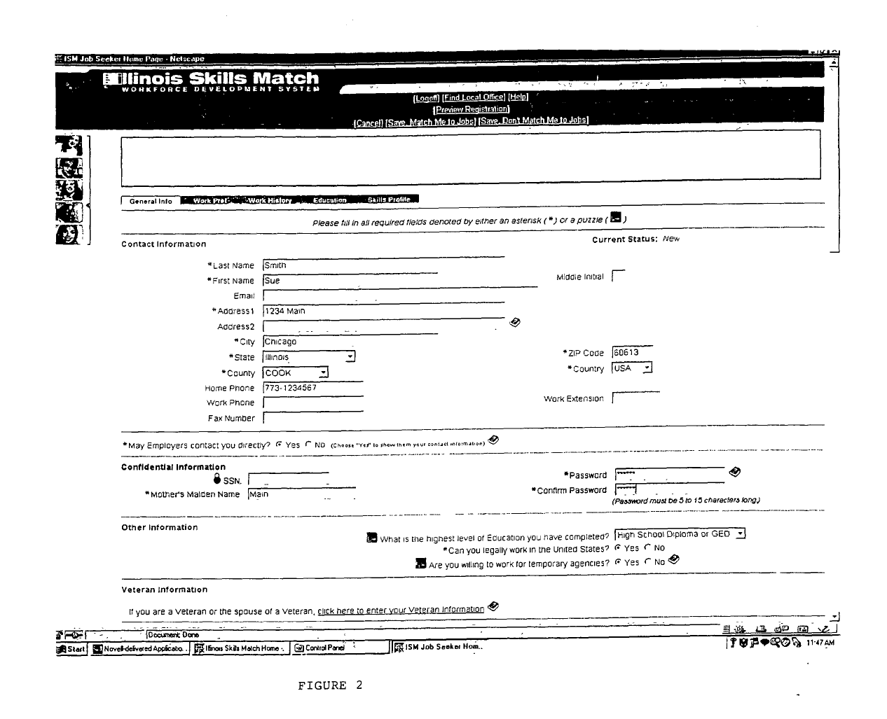

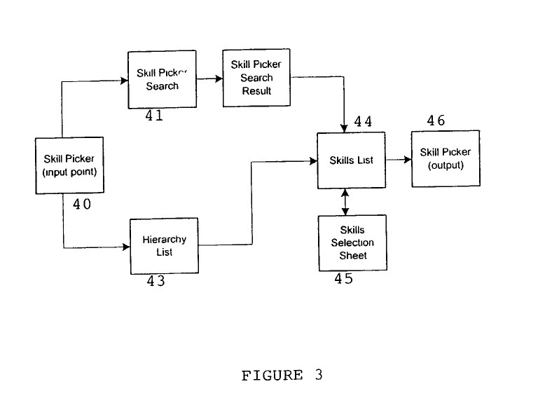

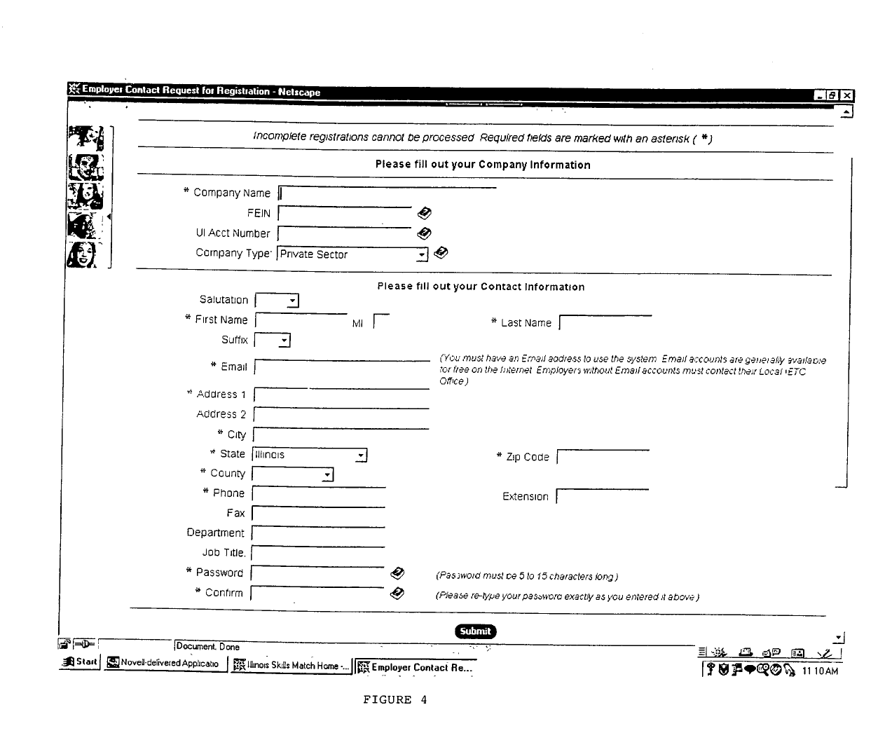

At the top level of the site navigation map illustrated in FIG. 1, there is a home page 1. On that page, the user makes a choice to indicate whether they are a job seeker 2 or an employer contract 3. Staff members log onto the system separately from the home page 1 on the staff Login 4. Login procedures require the entry of a valid username and password, or the user is required to complete the registration process to create a username and password. The registration process for the job seeker is illustrated in FIG. 2. In order to complete the registration process, FIG. 3 illustrates that the job seeker must input skills at the input point 40. The skills List 44 is determined either through a skill search 41 or a hierarchy list 43. The Job Seeker then chooses their skills from the skill selection sheet 45. Output is through the output point 46. After registration is completed the user can logon to the system. The employer registration 3.1 is illustrated in FIG. 4 and also requires the additional step of verifying the employer's registration information 3.2. Once the registration process is completed, the employer may post job order 3.3.

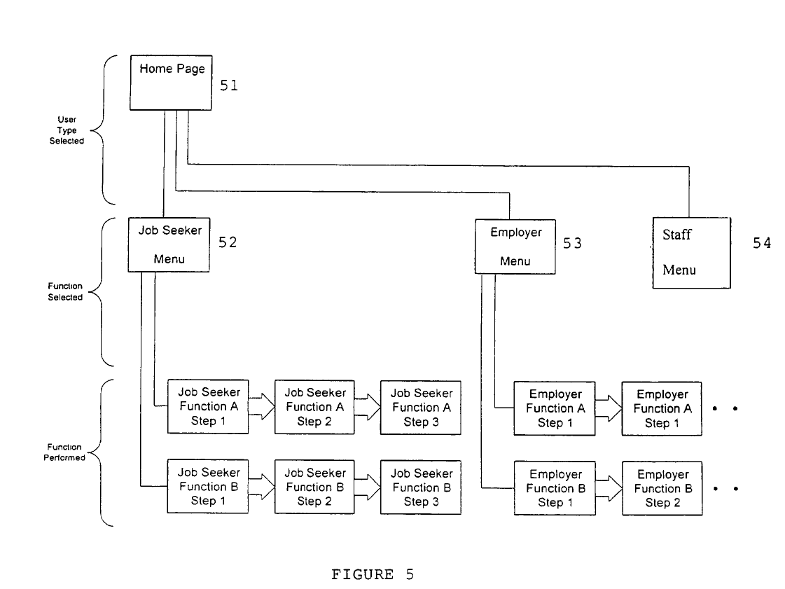

Once the user type is identified and their username and password is authenticated, a customized menu of function options is made available. FIG. 5 illustrates one embodiment of the general organization of web pages to provide customized menu of function options. From the Home Page 51, the user type is selected. From either the Job Seeker Menu 52 or the Employer Menu 53 a function is selected. The function is then preformed through a step or series of steps. The step or steps of the selected function may be presented to the user as a single web page, or a series of web pages. A separate URL is required to access the Staff Menu 54.

As illustrated in FIG. 1, the Job Seeker may choose the Job Seeker Tab 2.1 and the Qualified Job List 2.3 will automatically present itself from the Job Seeker Tab 2. 1, the Job Seeker can choose to Print Registration 2.2. Qualified Job List 2.3 allows the Job Seeker to View Job Information 2.5. A link to a mapping component 2.6 is also provided. There are several components that interplay with the Job Seeker Search Results 2.4. These components include Update Job Seeker 2.7, List Job Seeker Communications 2.8, List Job Seeker 2.9, Add Job Seeker Services 2.10, List Communications 2.11, and Job Seeker Mass Call-In 2.12.

As further illustrated in FIG. 1, the registered Employer, once logged into the system, will view the Job Order List 3.3. The Job Order List 3.3 lists the position openings provided by the employer-user. From the Job Oder List 3.3, several functions may be performed. These functions include: Job Order Statistics 3.30; Job Order Search 3.31; Update Contact Information 3.32; Job Order Tab 3.33; Recruiting Action List 3.34; Qualified Candidate List 3.35; and View Job Seeker Information 3.36. The Job Order Statistics 3.30 function provides statistical information regarding a position opening (job order). The Update Contact Information 3.32 function allows the employer-user to alter contact information for a job order, thereby assuring that the most accurate contact information is presented to the job seeker. Job Order Tab 3.33 allows the employer-user to create a job order. The Recruiting Action List 3.34 function allows the employer-user to determine the actions taken on a job order. Such actions include the recruiting outcome. The Qualified Candidate List 3.35 provides to the employer those job seekers whose skills are compatible with those provided in the job order. The View Job Seeker 3.36 function provides the Employer-user with the information on job seekers contained with the Qualified Candidate List 3.35.

As further illustrated in FIG. 1, once a staff member logs into the system, Staff Menu 4.1 is presented. The Staff Menu 4.1 allows the staff member to access all of the Job Seeker and Employer-user functions, as well as the List Employer-user Requested function 4.11, BFS Mirror Search function 4.12, Job Seeker Search function 4.13, Search Employer Information function 4.14. The List Employer Requests function 4.11 allows the staff member user to see the job orders for a particular employer. The BFS Mirror Search function 4.12 permits the staff member user to search the system. The staff member user may also engage the Job Seeker Search function 4.13 to locate a particular Job Seeker's information contained within the system. The Staff Member user may also utilize the Search Employer Information function 4.14 to obtain data regarding a particular employer on the system. The system also allows a staff member user to update employer contact and job order information, update employer services, and add employer services. This is accomplished through a series of staff-specific web pages.

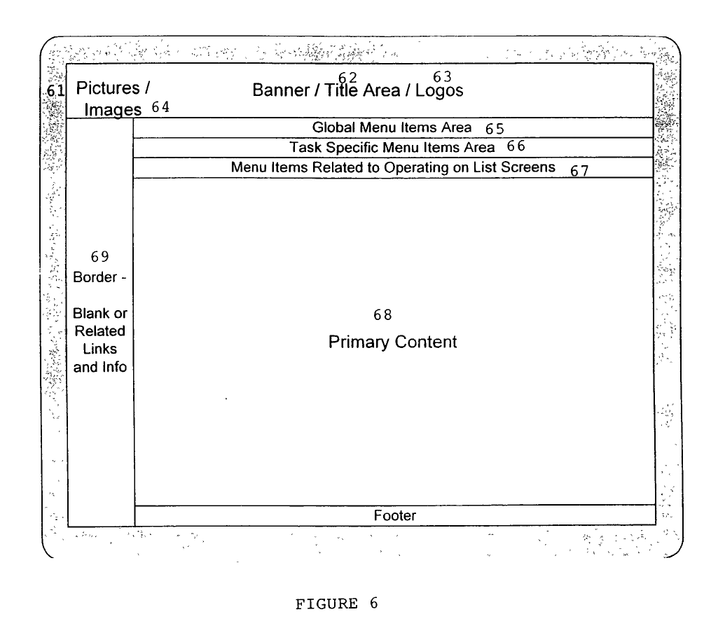

FIG. 6 is an illustration of the general layout of a typical web page for one embodiment of the present invention. The top banner portion 61 provides the title 62 and the logos 63. The top banner portion may also contain various graphics, depicted as Pictures/Images 64. A horizontal strip of global controls 65 is displayed below the top banner portion 61. When applicable, a horizontal strip of task specific controls 66 appears below the global control strip 65. If the page is a list page, a third horizontal strip of menu items related to operating on list screens 67 is available directly below the task specific controls 66. The main body of the typical web page with the primary content 68 follows below the horizontal strips. The main body 68 is where data elements and input/output are performed. A vertical control strip 69 of controls runs along the left hand portion of the main body 68, providing an additional set of global controls. Links to other job related materials are provided on the vertical strip when appropriate to the user type and function being performed.

The pages in the potential positionee/positionor web site can be broken down into five basic categories: the home/logon page, menu pages, search pages, list pages, and detail pages.

Login Page

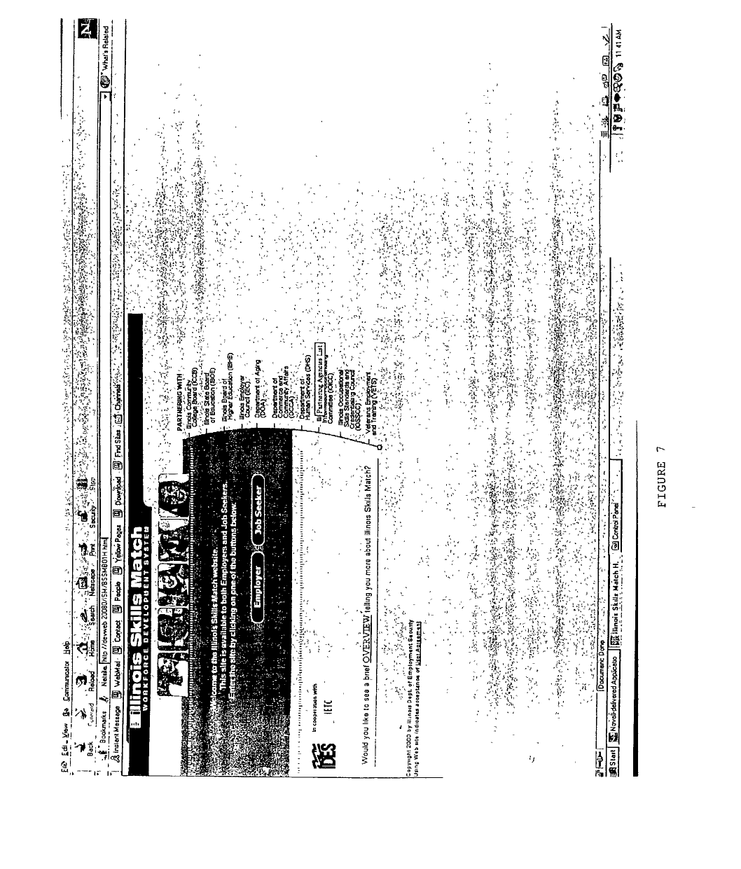

The home/login page shown in FIG. 7 is in its own category due to its processing requirements. The initial home page identifies the user type and requests a username and password. At this point, secure sockets layer (SSL) is used for transmitting this information to the web server. Also at this stage, a number of evaluations are performed on the client browser. Once the browser capabilities and the user have been authenticated, a user-appropriate opening menu page is displayed depending on the user type.

Menu Pages

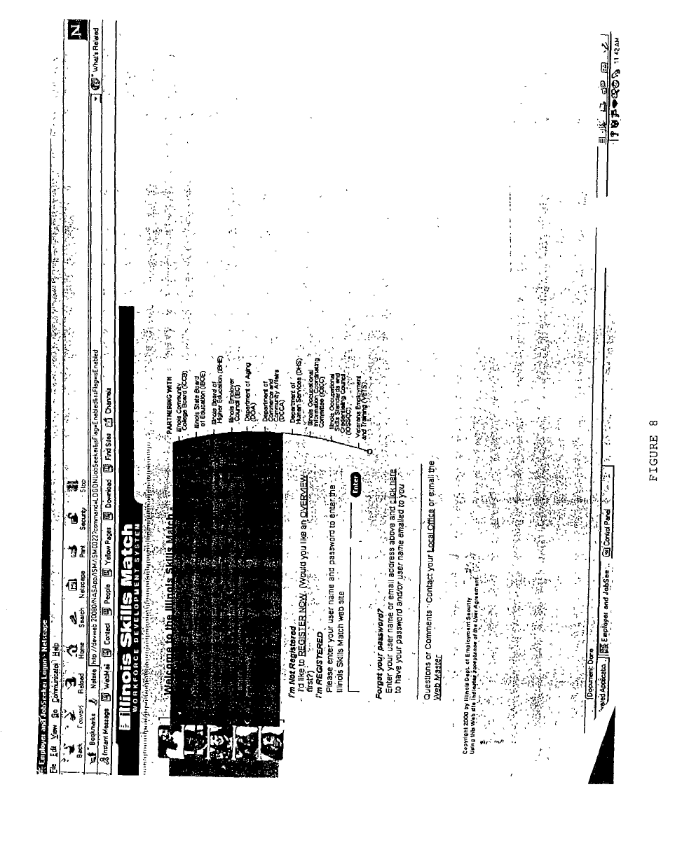

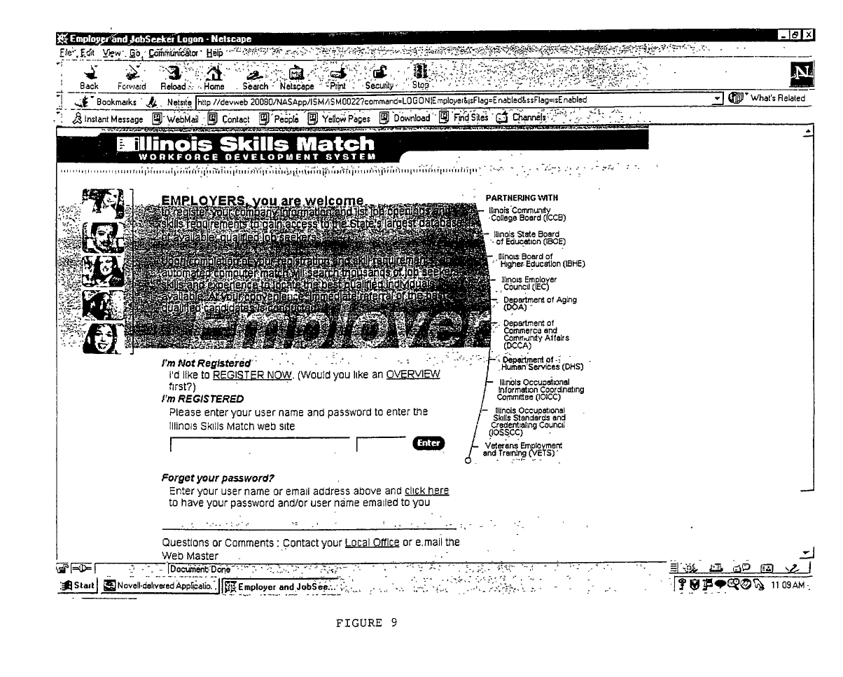

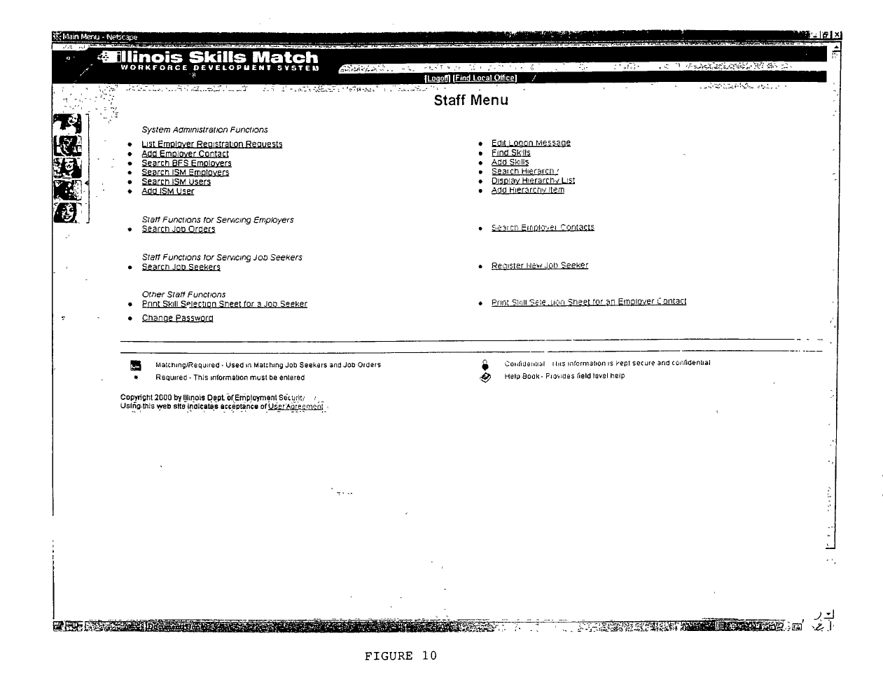

Menu pages shown in FIGS. 8, 9, and 10 are displayed as appropriate for the type of user, such as job seeker in FIG. 8, employer in FIG. 9, and staff in FIG. 10. A menu page contains no input controls, only links to other pages in the system. Some conditional processing is performed to show or hide specific menu options based on the user's permissions. An example of such conditional processing is the hiding of staff-specific menu options when the user is a job seeker or employer. These decisions are made when the page is constructed on the application server.

Search Pages

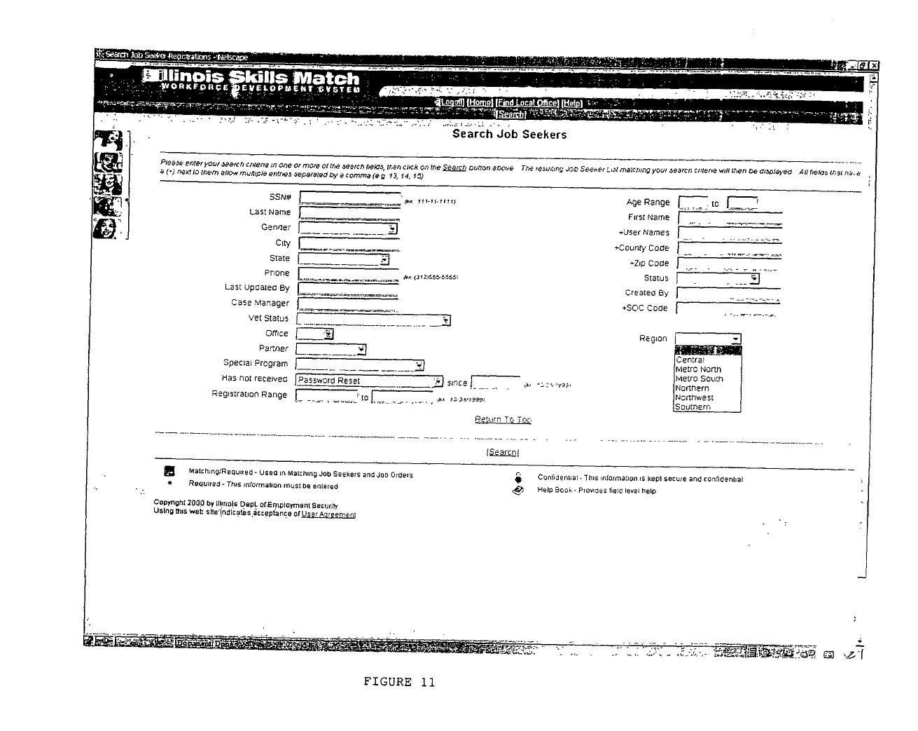

Search pages, such as the one shown in FIG. 11, accept search criteria, and then execute a database search for data with matching criteria. After the search is completed, a list page is built showing the results if one or more matching records is found. If no matching records are found, the search page is redisplayed with an error message.

List Pages

The list pages, such as the one shown in FIG. 12, list several rows of information from the database. This is typically a result set from a database search. Each result record is a link that can be used to present the detail page for that data row. Optionally, each line in the list may also contain a checkbox that can be used to select a subset of records. The selected set of records can span multiple list pages.

Initially, the result set is divided up into pages. If the result set requires more than one page of list information, navigation buttons will be available to proceed to the next or previous page as necessary.

When a user selects a detail record, and then returns to the list view, the user will return to the same list page that contained the detail record most recently viewed.

Other activity, such as an employer altering a job order, in the potential positionee/positionor system may introduce or eliminate records from the user's result set. However, once the list is generated, it remains static until the user requests for the information to be refreshed. When necessary, some processes force a refresh to occur.

Detail Pages

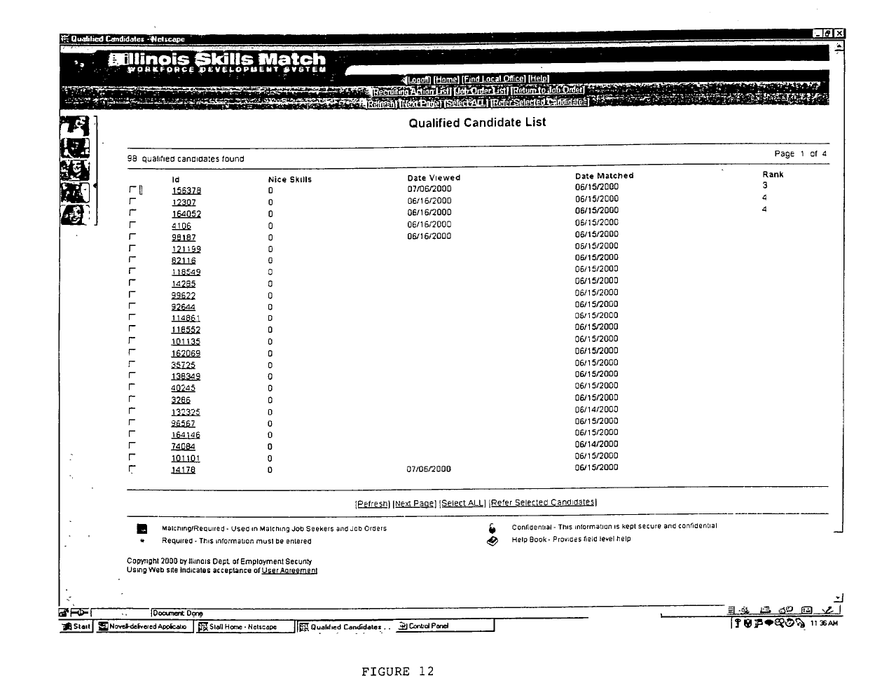

When complete detail on a record of information is requested, a detail page, such as the one depicted in FIG. 13, is presented. If a user requested the detail from a list page, then options on the detail page will exist to move through the list in detail view and an option to return to list view will be in place. If a subset of records was defined on the list page, then that subset defines the context of what the next/previous navigation, such as when a job seeker selects job skills, will present to the user. For example, when a job seeker selects skills, the next navigation can be directed towards providing the jobs that match the job seeker's skills.

In simpler cases, detail pages are displayed from other non-list pages, or used for data entry purposes.

Online Components

Screen Generation

The mechanics of generating a screen begins with the user's browser request. These requests can be sent to one of the potential positionee/positionor system web servers. If the request is for a static HTML page or other static content such as an image, the web server can handle the request by itself. In one embodiment of the present invention, the only static HTML page is the login page. The rest of the page requests are references to Servlets. In these cases, the requests are forwarded from the web server to the application server that is best suited to handle that request at that time. The best suited server can be determined through load balancing information that flows between the application servers, and from the application servers to the web servers.

The normal processing of an online screen can involve several steps, including:

Building the screen with input fields and any other controls;

Processing the input values, perform validation and database access; and

Providing a response, such as an error message or the presentation of the next screen in the process.

Programmatically, these functions can be split into separate modules. The building of the screen can be performed by a Java Server Page (JSP) for that screen. When the page is submitted for processing by the user, a Java Servlet can be called. After processing the information, the Servlet chains to the next JSP.

In one embodiment of the present invention, after a user is done entering data onto a web page form, some button click or other control function is performed by the user. At this point, validation of data is performed. The potential positionee/positionor system performs validation and enforcement of business logic at three different levels:

On the input form web page itself;

At the application server; and

At the database.

In one embodiment of the present invention, the potential positionee/positionor system can be broken down into five sections:

Job seeker functions;

Employer functions;

Staff functions;

Administration functions; and

Matching functions.

Job Seeker Functions

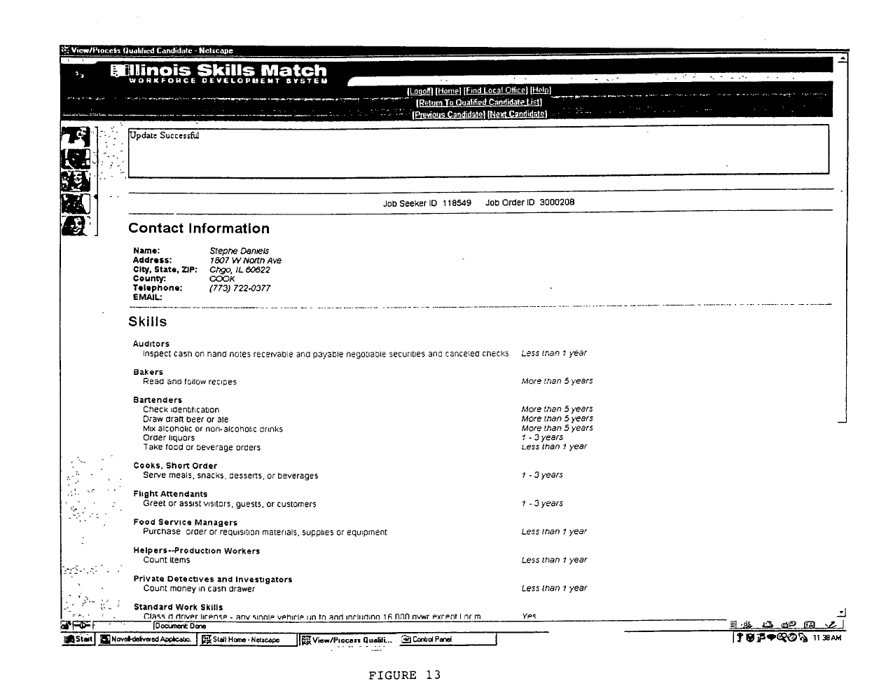

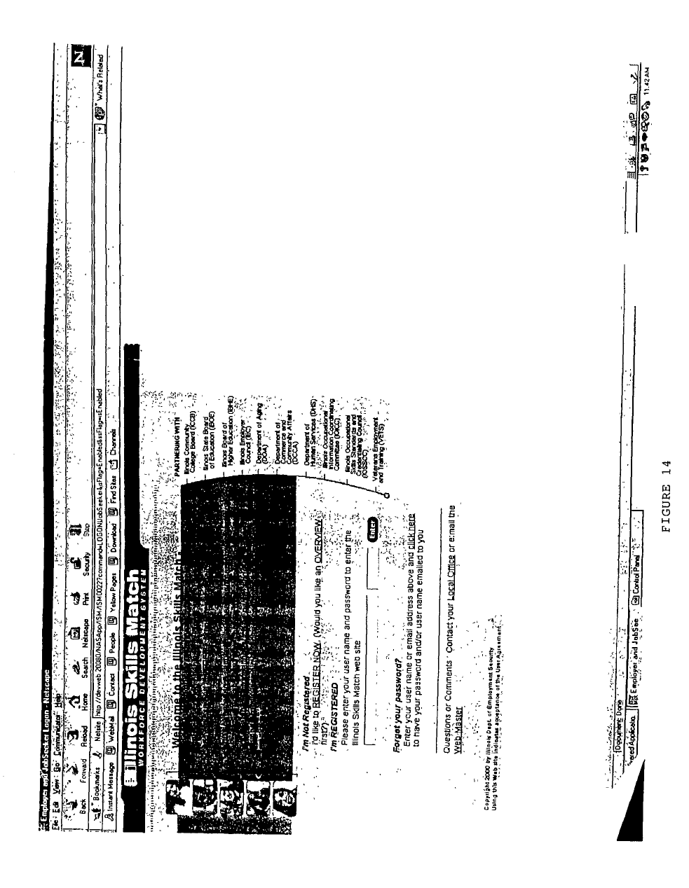

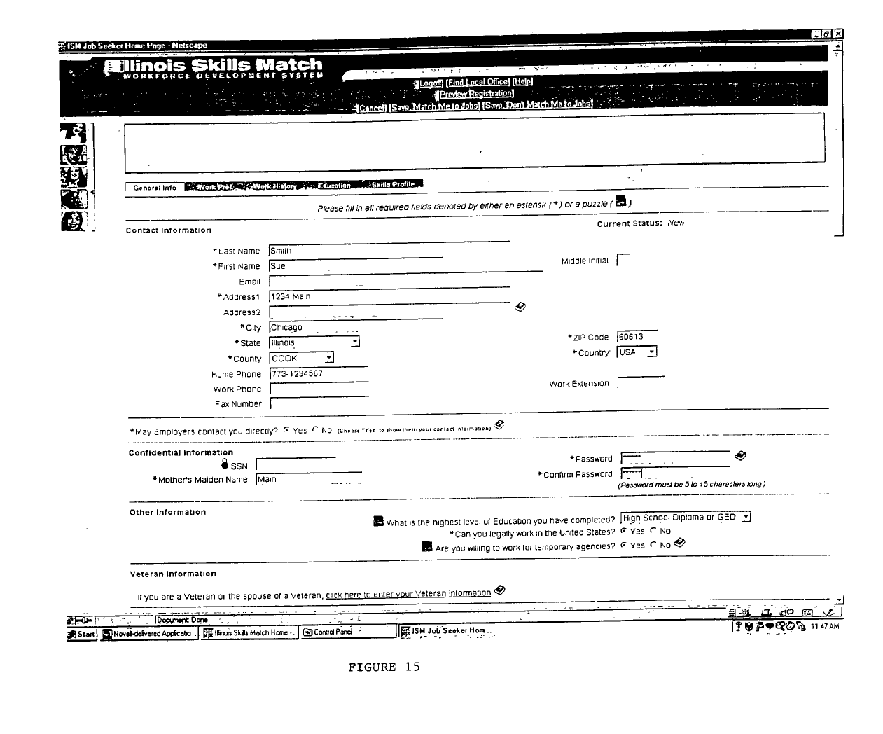

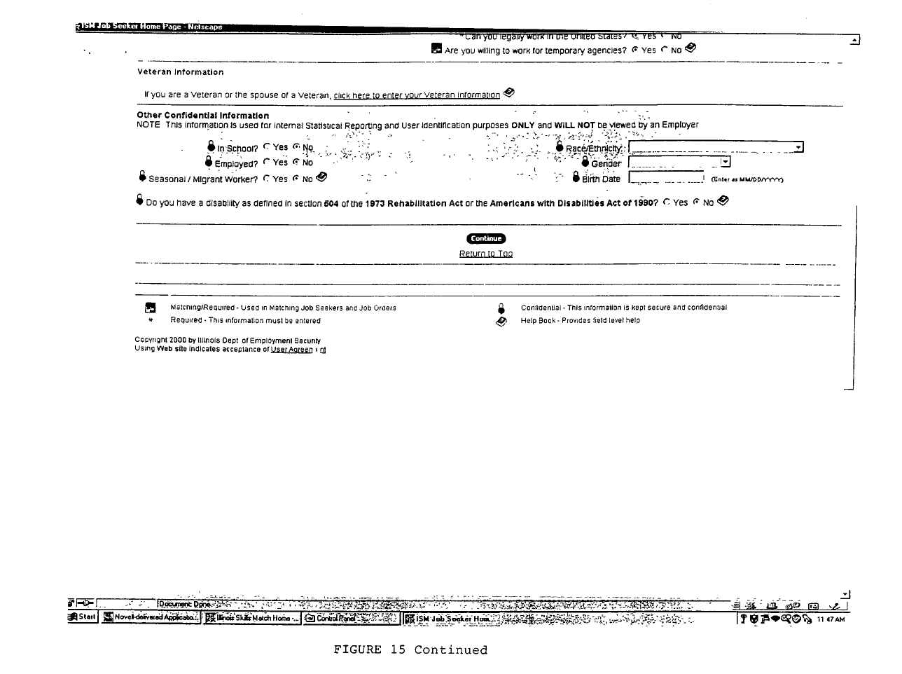

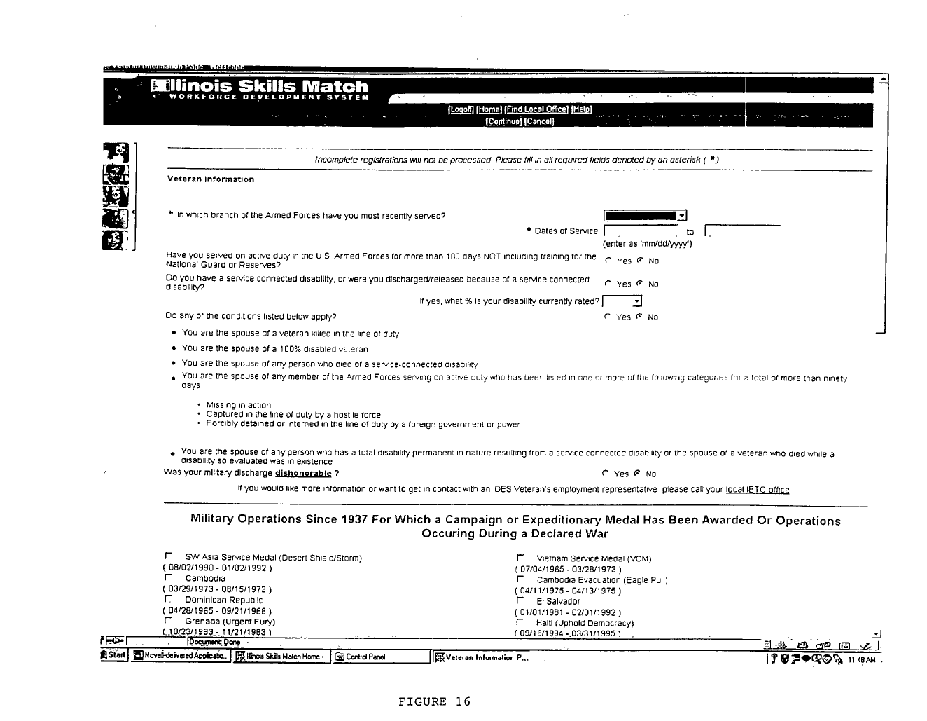

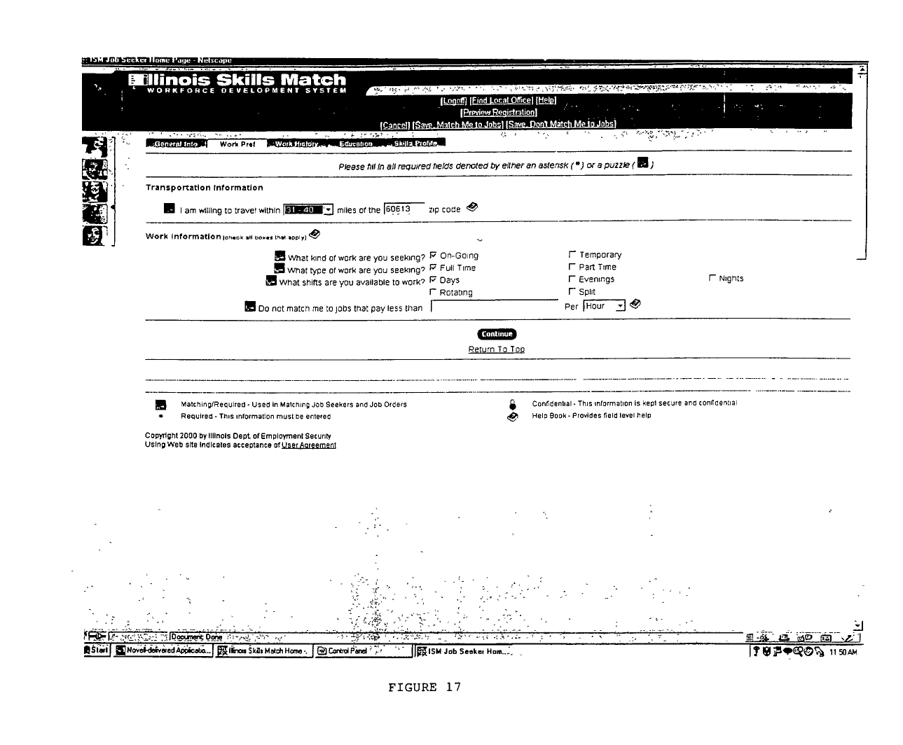

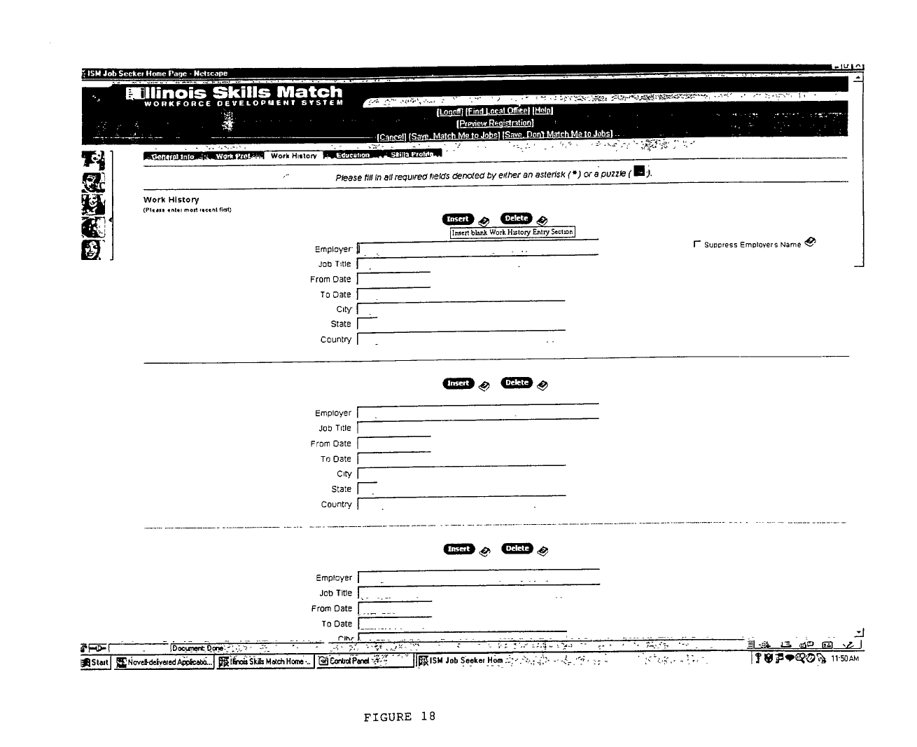

In one embodiment of the present invention, a job seeker begins his experience with the potential positionee/positionor system by registering, as shown in FIG. 2. Only registered job seekers with a username and password can use the system, as illustrated in FIG. 14. Registration is a simple sequence of forms. These forms, shown in FIG. 15, require that the job seeker input contact information, confidential information, other information, such as the highest level of education completed and willingness to work for temporary agencies, veteran information, and other confidential information. The only field that prevents a person from entering a profile on the system more than once is the field for social security number entry, since duplicate social security numbers are not allowed. FIG. 16 illustrates veteran information, including a series of questions as well as a checklist of military operations designed to ascertain the veteran status of a job seeker. There are also forms for transportation and work information. The transportation form, shown in FIG. 17, is designed to allow job seekers to limit matching jobs to those within a certain distance of a zip code. The work information, also shown in FIG. 17, is directed at limiting job matches to those jobs which fit the job seekers desired work schedule and salary requirements. Optional forms for work history, FIG. 18, and education, FIG. 19, are to provide potential employers with additional information on the job seekers.

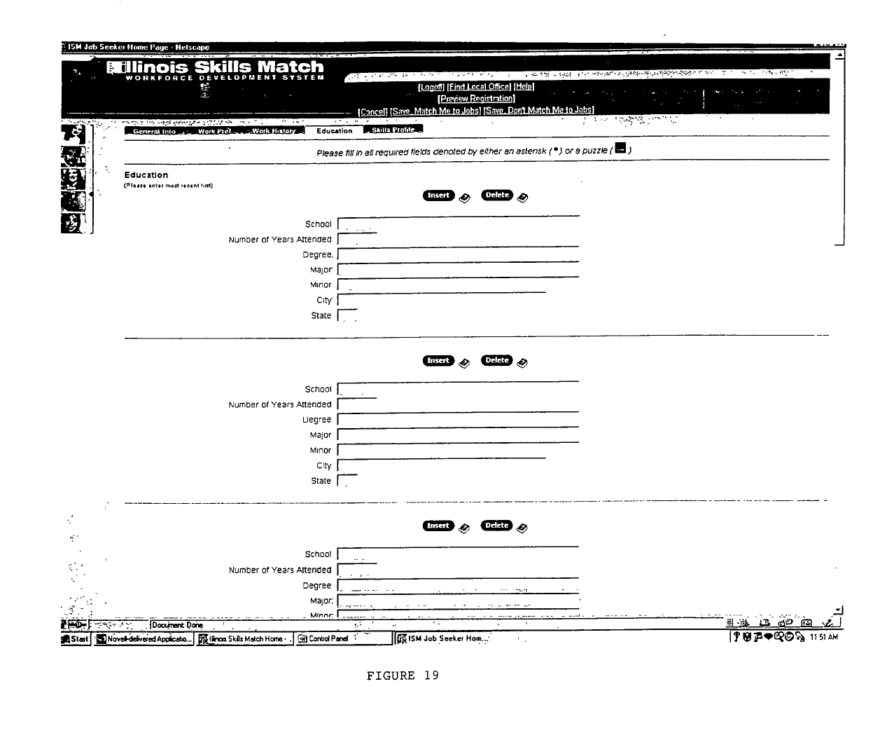

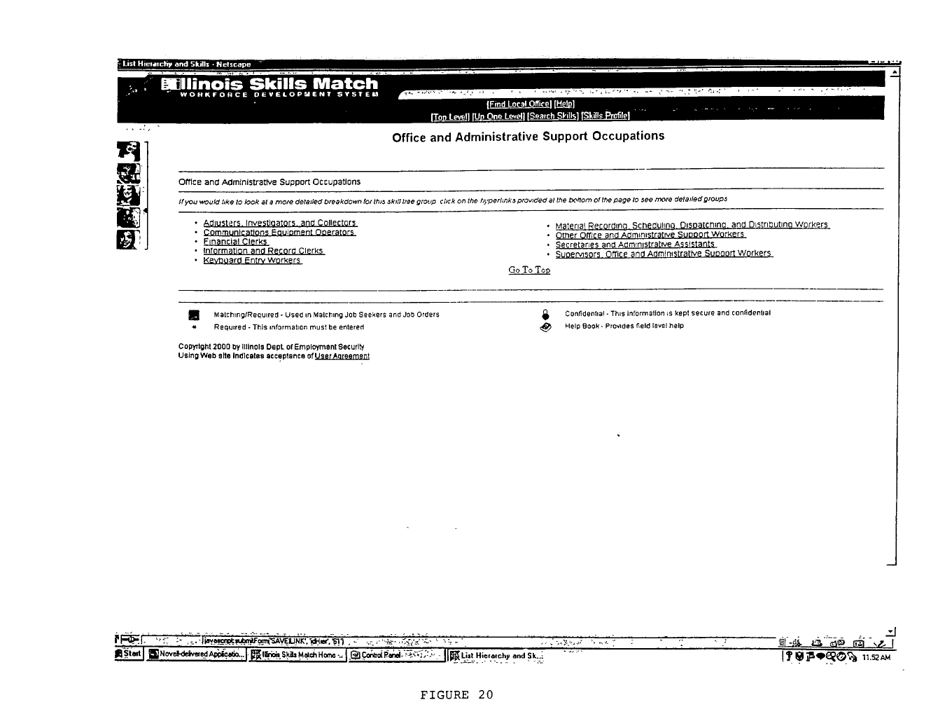

The job seeker can also provide the type(s) of positions sought, as illustrated in FIG. 20, from a hierarchy as well as the skills the job seeker has pertaining to the positions sought. The skills for a given position are predefined and are in the form of a checklist, as shown in FIG. 21. The skills are further separated by level of experience, also shown in FIG. 21. This series of forms is used to guide the job seeker through a series of predefined skills in order to add skills to the user's profile. The user selects skills and assigns predetermined proficiency or experience levels to the selected skills. Extensive searching is available to choose skills related to various job titles. This functionality is also available in the employer section to define the required skills for a job order. After the registration procedure is completed, the user can logon to the system by entering their user name and password into the login screen shown in FIG. 14. Once a job seeker has filled in his skills profile, the matching function can be performed by selecting “Save, Match Me to Jobs Now,” as shown in FIG. 21. Available job orders are then compared with the user and a list of matching job opportunities that correspond to the job requirements is presented. The profile for the job seeker is also saved in the system. Links to the detailed job information is available for matching job orders. Job seekers may also view a map showing the job location. The job seeker can also select “Save, Don't Match Me to Jobs,” as shown in FIG. 21. This also saves the job seeker's profile, but does not match the profile to the job orders. A job seeker can also choose to be removed from the qualified candidate list. Employers are not notified of the job seeker's non-interest.

Employer Functions

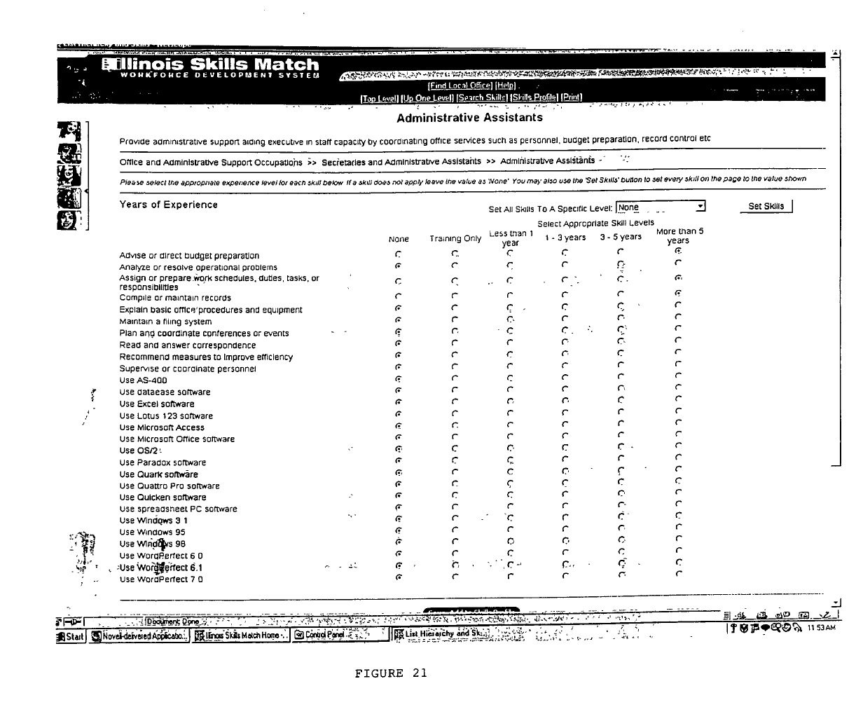

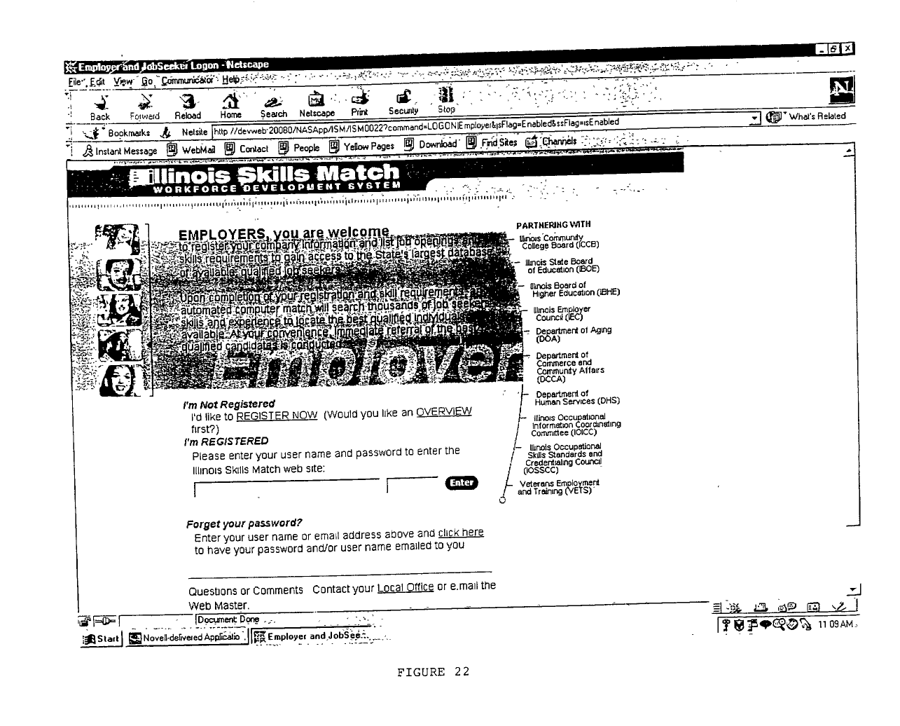

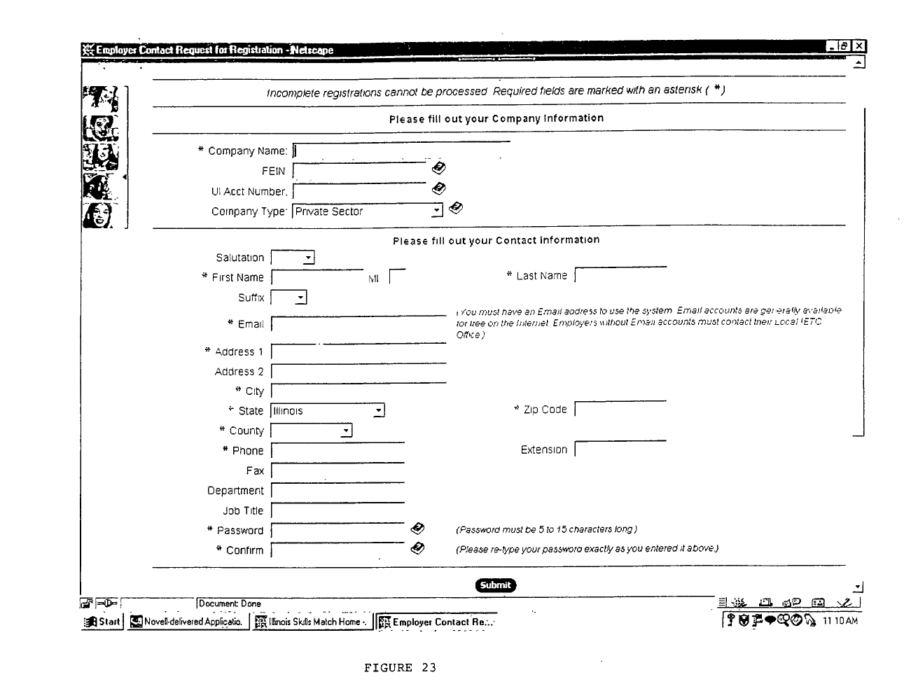

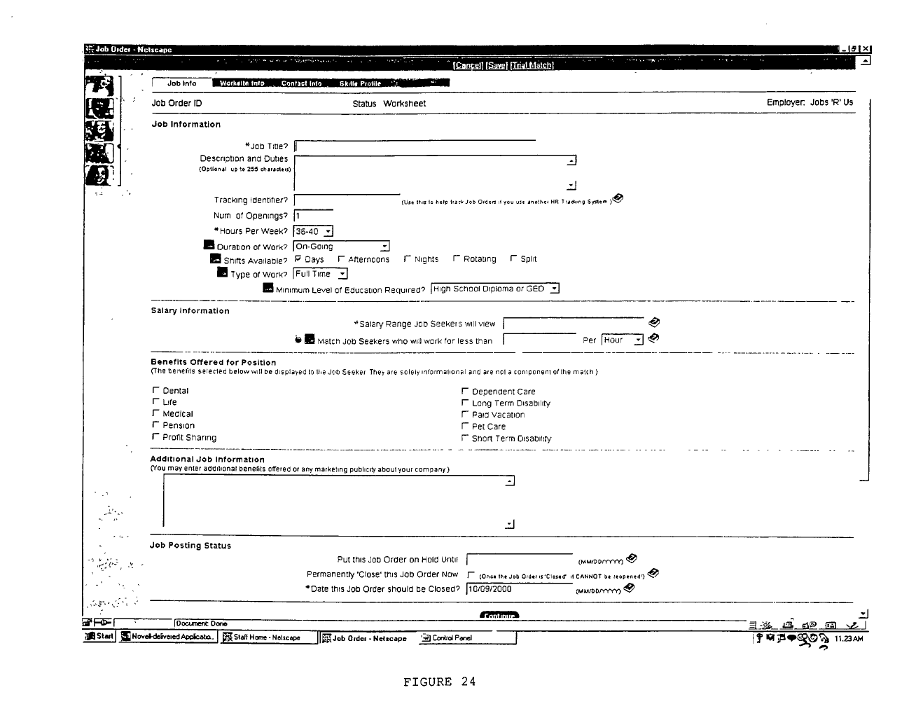

In another embodiment of the present invention, employers must be registered prior to posting any job orders into the system. FIG. 22 illustrates the employer login requiring a user name and password. FIG. 23 shows that to obtain a user name and password, the employer must input company information and contact information. This information is then reviewed by organizational staff to determine the validity of the employer. Once the employer goes through the online registration, job order worksheets can be prepared. The job order worksheets, such as the one illustrated in FIG. 24, contain fields for inputting job information, salary information, benefits information, additional job information, and job posting status. The job information includes fields for entering the job title, job description and duties, tracking identifier for tracking job orders, number of openings, hours per week, shifts available, type of work (full-time, part-time, etc.), and minimum level of education required.

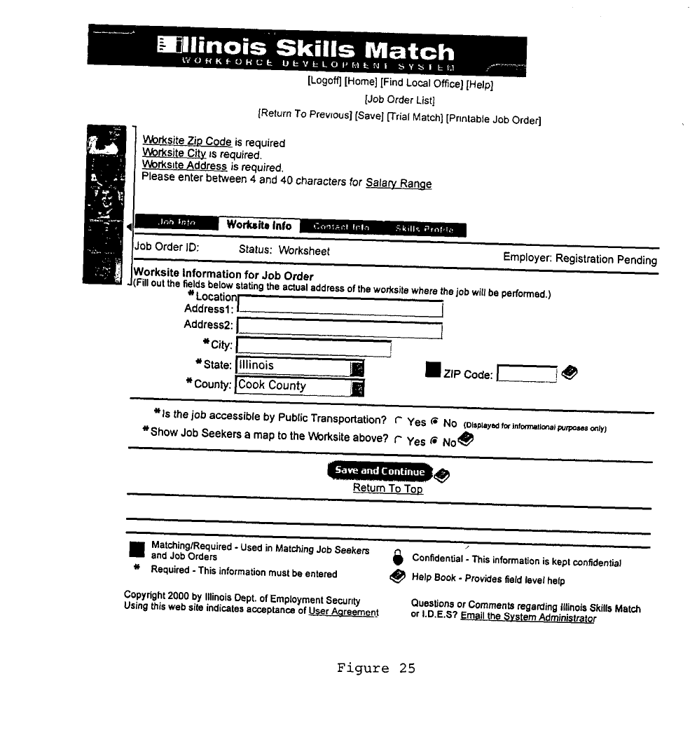

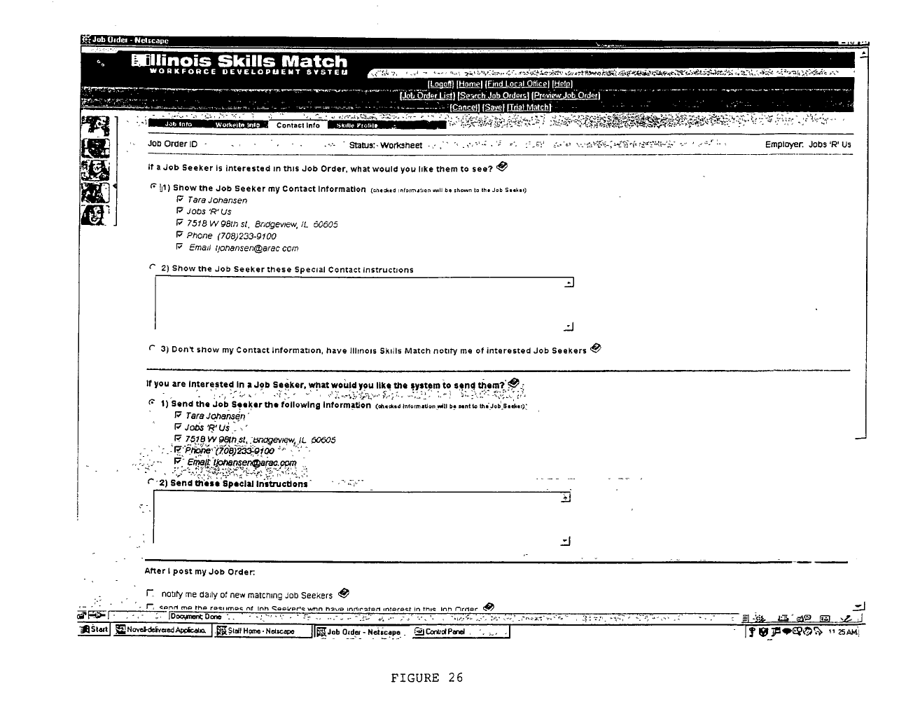

Once this information is entered into the system, the worksite information for the job order is entered. FIG. 25 depicts the form for entering the worksite information. The worksite information includes fields for entering the job location address, an additional job location address, city, state, and county for the position. The worksite information also allows employers to state whether the position is accessible by public transportation. The worksite information further allows the employer to give permission to the system to provide the job seekers with a map to the position's location. The job order may also provide, at the employer's election, the employer's contact information, as shown in FIG. 26. Additionally, FIG. 26 also illustrates that the employer can elect to have daily notifications of new matching job seekers, or notifications in another time frame, as well as requiring the system to send resumes of job seekers who have indicated an interest in the job order.

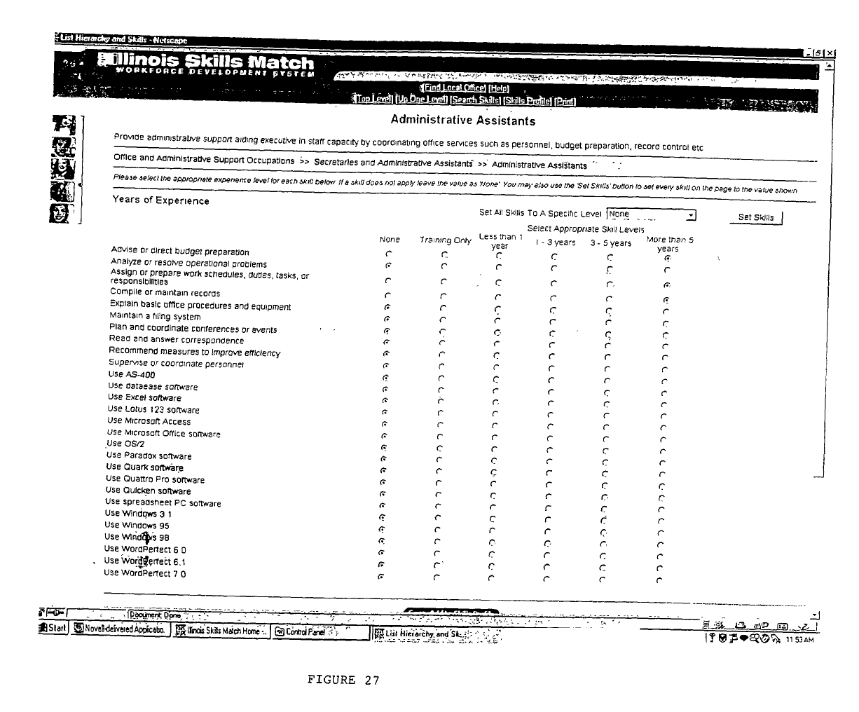

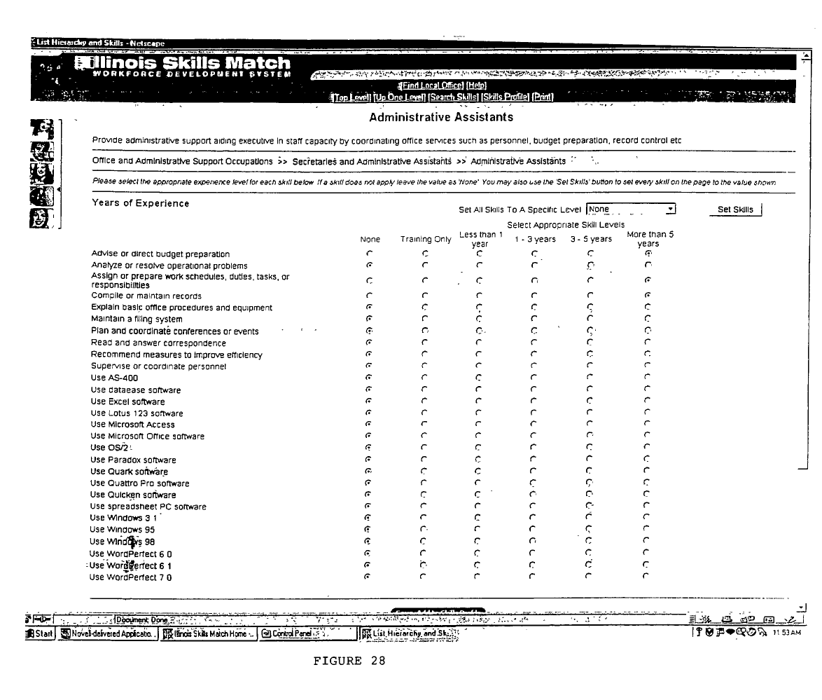

The employer may also provide the type(s) of positions sought to be filled, as well as the skills the job seeker has pertaining to the positions sought, as illustrated in FIG. 27. The skills for a given position are predefined and are in the form of a checklist, as shown in FIG. 28. The skills are further separated by level of experience, also shown in FIG. 28. This series of forms is used to guide the employer through a series of predefined skills in order to add skills to the job order's profile. The user selects skills and assigns predetermined proficiency or experience levels desired for the position to the selected skills. Extensive searching is available to choose skills related to various job titles. However, these job orders cannot be posted to the system until the registration has validated the legitimacy of the employer. The job orders may be categorized by their status as not-posted, posted, closed, or on hold/held. A job order that is not posted is a worksheet. The job order worksheet allows the employer to create complete job orders. The posted job order is a complete job order, available for matching. A closed job order cannot be reopened. A job order that is on hold/held will close after a predetermined period. Prior to closure, a notification will go out to the employer regarding the on hold/held job order.

After a job order worksheet is completed, a trial match can be performed. This function allows the employer to determine how many qualified candidates exist in the potential positionee/positionor database, and may be performed prior to the employer's completed registration. No qualified candidate information is available to the employer, other than the number of qualified candidates. Modifications to the job order worksheet can then be performed prior to the actual posting of the job order. These modifications to the job order worksheet can alter the number of qualified candidates for a job order. Once posted, a match is performed and a list of qualified candidates is generated in the database. A job order can be modified after a match has been generated by the system. If a job order is modified after a match has been generated by the system, the system will generate a new match. The next time a qualified candidate logs onto the system, that new job will appear in their list of qualified jobs.

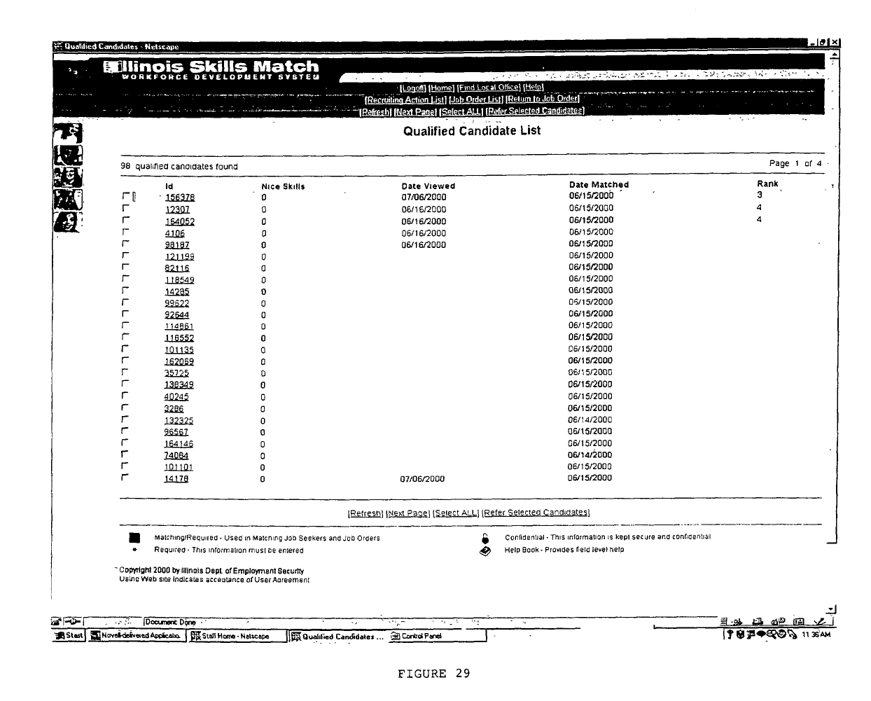

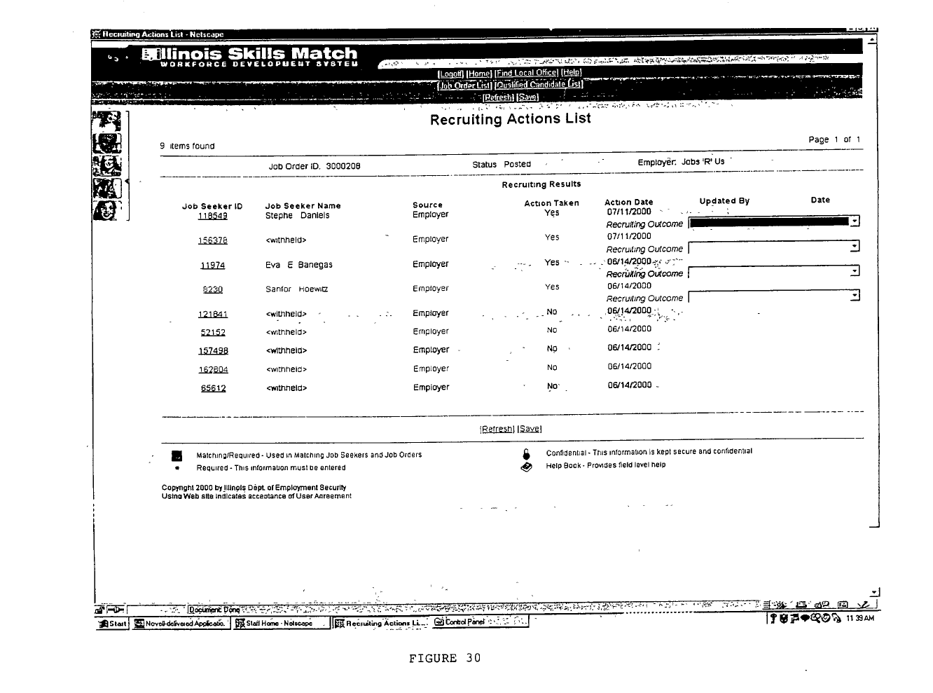

Once qualified candidates have been identified through the matching process, the employer can perform actions to view the job seeker information and make referrals. An example of the qualified candidate list is illustrated in FIG. 29. The employer is then free to take action towards the recruiting of qualified candidates. The employer can see the job seeker's information if the job seeker has not labeled such information confidential and the employer takes a recruiting action. Upon taking a recruiting action, the action remains in the recruiting actions list, even if the job seeker never appears on the qualified candidate list again. The recruiting actions, shown in FIG. 30, trigger notification of the job seeker of a match in skills between them and a job order. Notifications are queued and processed in batch mode. Possible notification methods are an email, automated phone notification, or a letter. If no email address for the employer is provided, then the employer must be staff assisted.

A record of every action conducted by a user is maintained by the system. The system can maintain records on whether the job seeker or employer first expressed interest. If a job seeker expresses interest first, that information is communicated to the employer. If an employer user expresses interest first, that information is communicated to the job seeker. If a “no interest” response is expressed, that information is not communicated.

Staff Functions

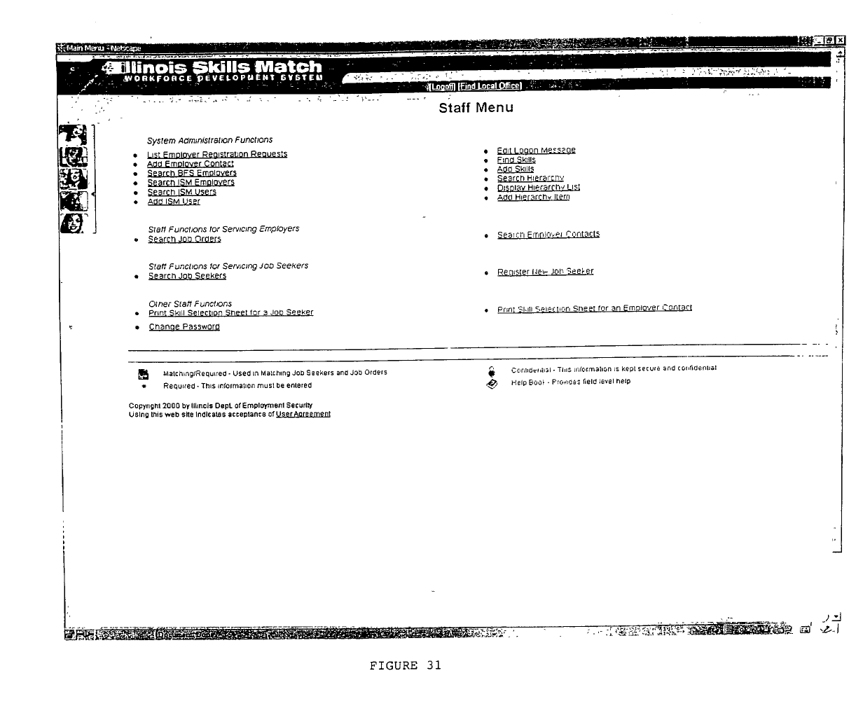

In yet another embodiment of the present invention, the staff menu, illustrated in FIG. 31, is presented when a staff user logs on to the potential positionee/positionor system. The staff menu contains links to every function available to both the job seeker and the employer. Employers can be registered by staff, or employers can submit their own registration requests. The staff member may label the job order as qualifying for a special program, as shown in FIG. 32. A staff member is the only user able to classify a job order with a special programs designation. Additionally, staff users can identify, and the system will maintain records for, additional service activities provided to the job seeker.

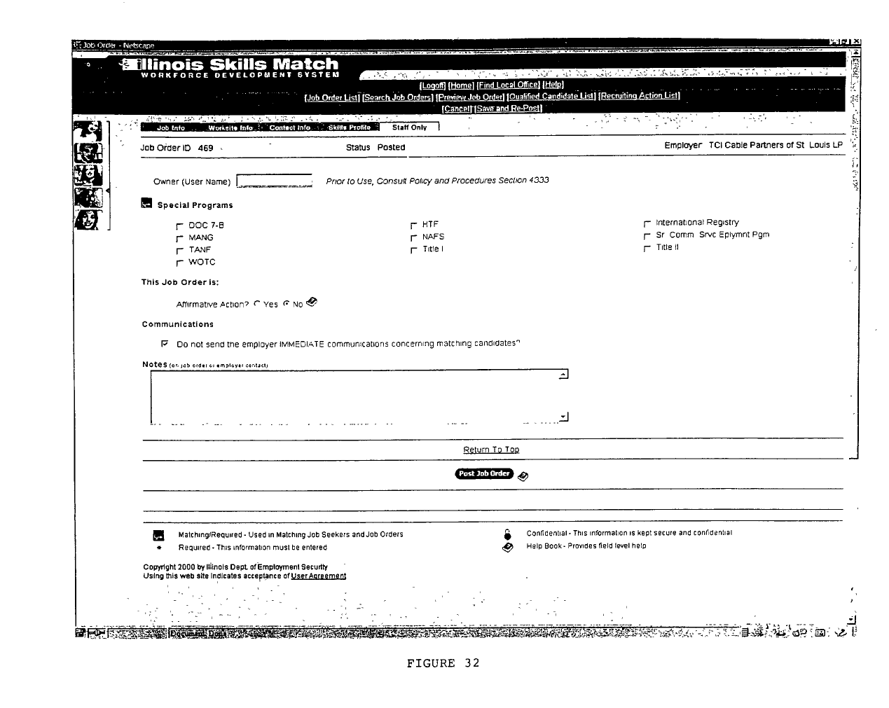

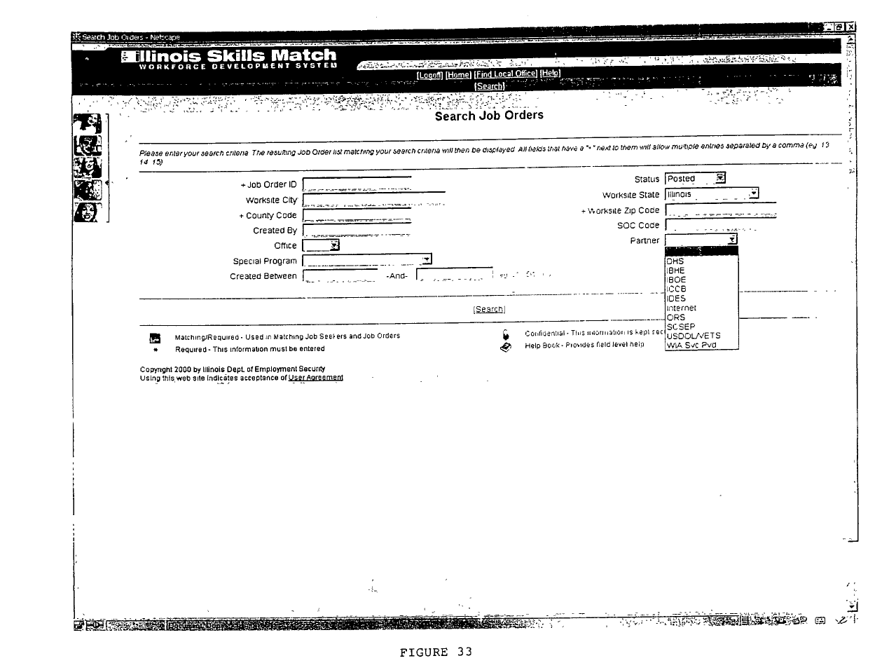

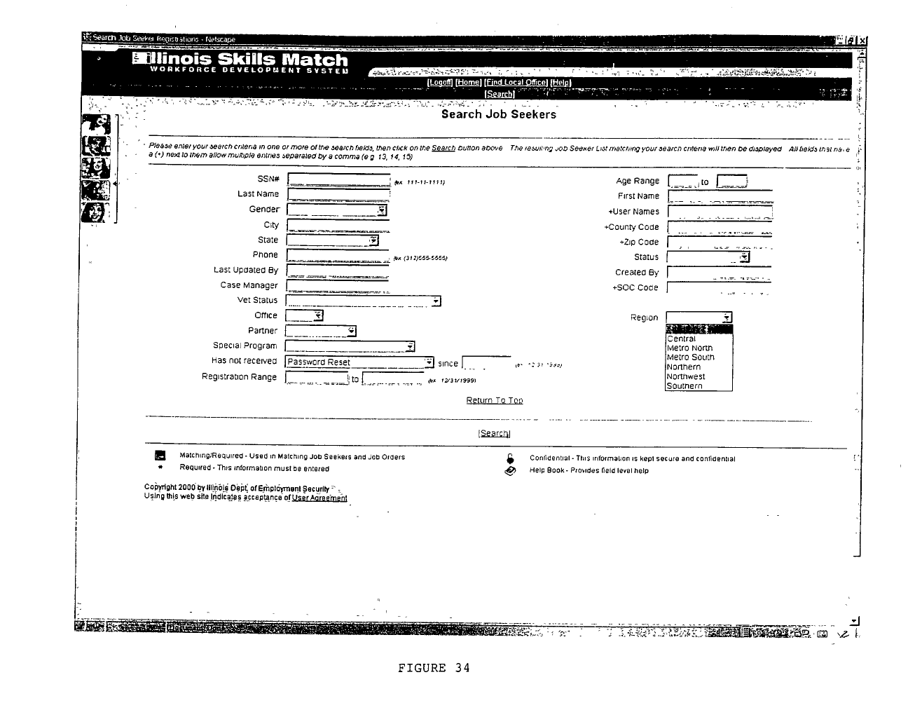

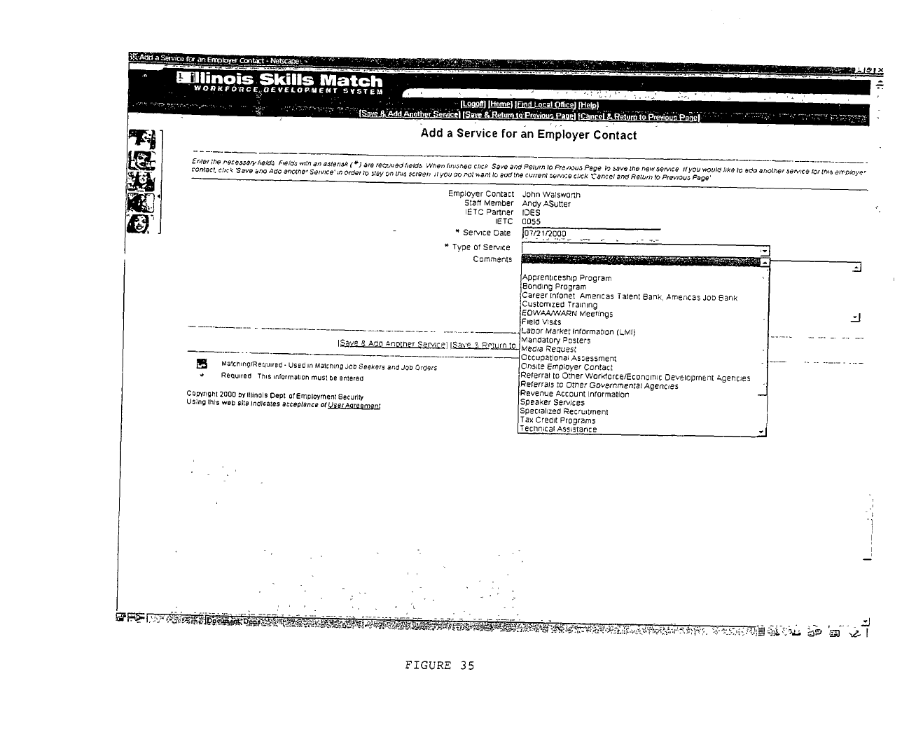

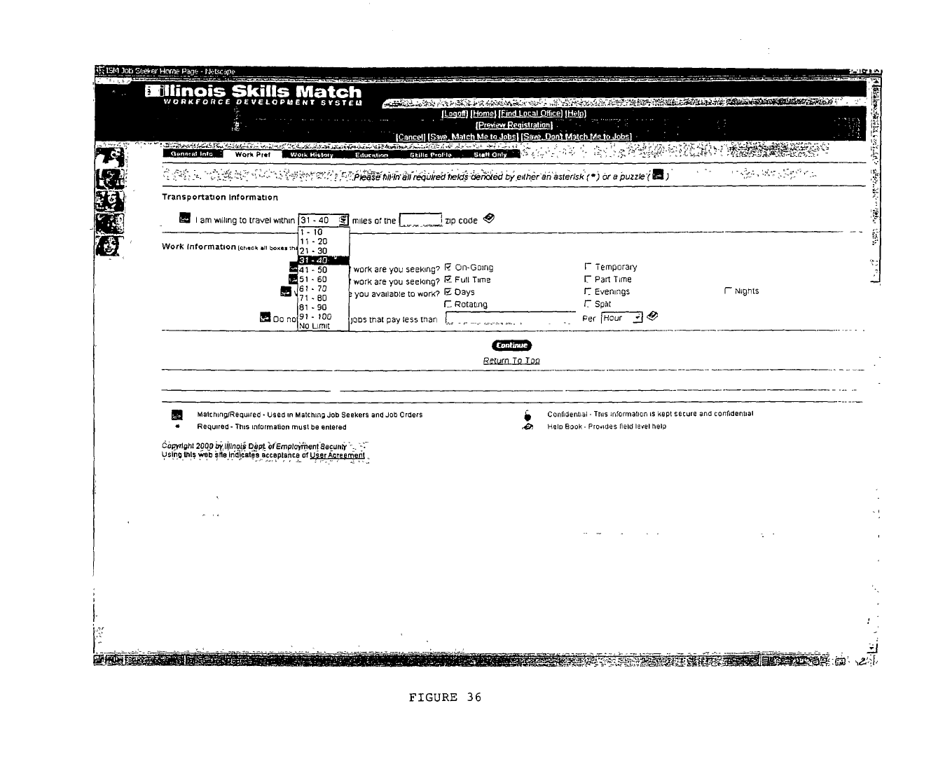

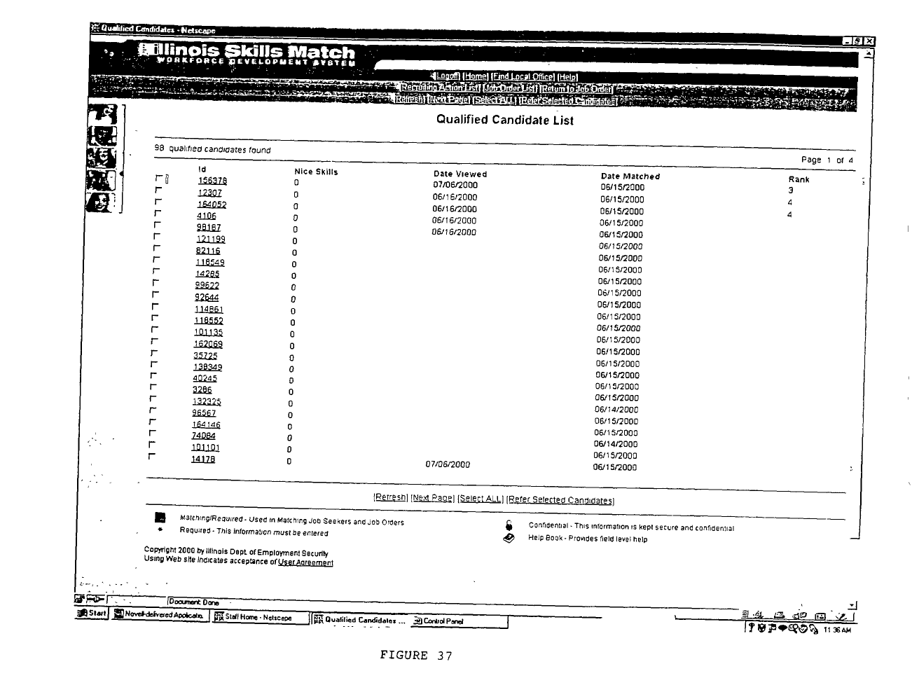

Staff search screens, such as the one illustrated in FIG. 33, allow the staff member to look up job orders by any one or more of a number of fields. These fields include job order ID, county code, and worksite zip code. Additionally, there is also the ability to search for job seekers, shown in FIG. 34, through a variety of profile fields. The staff user can also choose to send notification to the job seeker. The job order search screen provides staff members with a method to search for and edit a specific job order. Job order information can also be printed. The staff member may also edit employer company information, edit employer contact (FIG. 35) and other information, such as transportation information and work information (FIG. 36) as needed. Employer information can also be printed. Searchable fields denoted with a “+” sign indicate that searches can use multiple search terms. All search results can be printed.

If a job seeker or employer user forgets their password, a staff user can provide a temporary password. Upon entry of the temporary password, the system requires the job seeker or employer user to change the temporary password to a new, permanent password.

Administration Functions

Administrative screens are used to maintain the various basic data of the system such as skills definitions, staff users, security settings, and other table maintenance.

Matching Functions

The present invention is directed towards aligning a job seeker with an employer, in order to facilitate employment. To accomplish this goal, a matching function is required to generate matches between job seekers and employers. The matching application generates matches between job seekers and employers on the basis of job requirements provided by the employer. The job seeker's profile must be identical to the job requirements provided by the employer in order to generate a match. The requirements include the fields of: the highest level of education completed; the willingness to work for temporary agencies; the willingness to travel a distance from a zip code; the kind of work sought; the type of work sought; the shifts available to work; and salary. The skills that were entered independently by both the job seeker as skills held, as shown in FIG. 21, and the employer as skills required, as shown in FIG. 28, are used for the purposes of rank-ordering.

The matching application then correlates the job requirements held by the job seekers with those required by the employer to generate job seeker/employer matches. Matches are provided to the employer in the form of a qualified candidate list, as shown in FIG. 29. Once the employer makes a recruiting action, the job seekers are notified of the matches. The recruiting actions, shown in FIG. 30, trigger notification of the job seeker of a match in skills between them and a job order. Notifications are queued and processed in batch mode, described below. Possible notification methods are by email, automated phone notification, or a letter.

The matches are also rank-ordered by the relational application. The rank-ordering of completion of another batch job.

In another preferred embodiment of the present invention, the batch programs for the potential positionee/positionor system run in a Unix environment. In Unix, batch jobs can be either a single executable program, or a shell script. A shell is simply a term for the command line interface to the operating system. Several different shell programs are available in the Unix environment. Examples of these are Bourne, Korn, C, and Bash. Potential positionee/positionor system Batch jobs are written as Korn shell scripts. Korn shell is the most common and popular Unix shell. Within the Korn shell script, individual programs can be executed, environment variables can be used, and basic control structure constructs are available. Return codes from programs can be checked within the script. Return codes from the script can be checked by COSbatch.

In yet another preferred embodiment of the present invention, the core processing of the batch programs is written in Microfocus COBOL.

Two important design features of potential positionee/positionor system batch jobs is their ability to be restartable and their use of checkpoints. Many of the programs in the potential positionee/positionor system will be dealing with large amounts of data. If for some reason the job is interrupted, the ability to restart the job and have it resume processing where it left off saves valuable processing time and reduces performance impact on the system. From an operational standpoint, this approach offers simplicity. Any program can be terminated and restarted without the need for a lengthy manual rollback process.

Central to the checkpoint/restart infrastructure is a batch control table that contains key information about the execution parameters and status of the job. Information contained here includes input/output file name(s), the current status of the job, and an indicator of where in the file the last checkpoint occurred. There is also a checkpoint governor stored in the table that indicates the number of records to be processed in between checkpoints. This allows for some tuning of resource utilization. This technique limits the number of database locks and the length of time that records stay locked. The checkpoint value is read at the end of each checkpoint interval so that the parameter can be set dynamically.

Many batch programs in the potential positionee/positionor system either generate a data file for the mainframe from data contained in the potential positionee/positionor system, or read a file created on the mainframe and post the information into the potential positionee/positionor system database.

The mechanics of sending and receiving files between the potential positionee/positionor system batch server system and the IBM mainframe consists of dropping files off and reading them from a specific location on the network. In a preferred embodiment, the transfer mechanism is FTP or an NFS mounted volume that can be accessed directly. This is to avoid manual intervention in all file transfers for the potential positionee/positionor system. Files should be dropped off and picked up by the programs automatically with no human intervention.

Infrastructure Components

The potential positionee/positionor system infrastructure can be defined as those components that provide core services to the rest of the application components. In one preferred embodiment of the present invention, the infrastructure centers around iPlanet Application Server. iAS based applications consist of off-the-shelf iAS servers to provide the core services and custom built application components to implement the application's specific business logic requirements. The custom built application logic components that execute on the server side consist of Java Servlets, Java Server Pages (Java embedded in an HTML document), and application server extensions written in Java and C++.

In another preferred embodiment of the present invention, requests are received from the web user and, via the web server, a specific Servlet is called upon to handle that request. The Servlet can access external resources such as databases. After processing is completed, a Servlet will typically either respond with an HTML stream back to the client, dispatch control to a Java Server Page (JSP), or a combination of the two.

Structuring the iAS application architecture to use separate components for static pages, dynamic page templates, query files, and executable logic provides a multi-tier application model. A great deal of flexibility is available in matching the best module type to the application module's task. The advantages of this scheme are that the application components are separated into manageable pieces according to the skills required to prepare them and by the functions that they perform. This also allows for greater re-use of components, simpler testing, and modular deployment. This supports a higher quality development result and minimizes the impact on system availability when deploying potential positionee/positionor system application software upgrades.

According to another specific embodiment of the invention, the following specific architecture details are part of the potential positionee/positionor system:

Logical Architecture

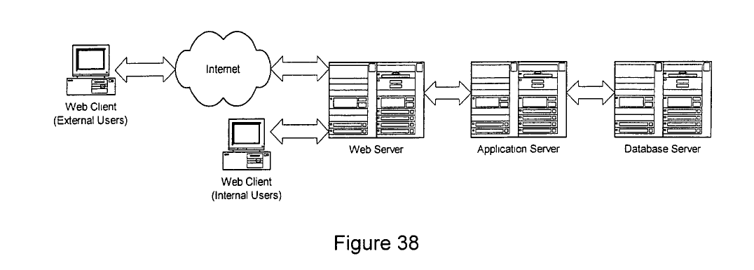

In one embodiment of the invention, the invention's technical architecture is implemented using a multi-tier architecture illustrated in FIG. 38. Users access the potential positionee/positionor system using standard web browsers which communicate with a collection of web servers. These web servers will serve static content such as static pages and images. Requests for dynamically generated pages will be forwarded to application servers. The dynamic content will be generated via programs invoked by the application servers. These programs will access and manipulate persistent data via a DB2 database on a separate server.

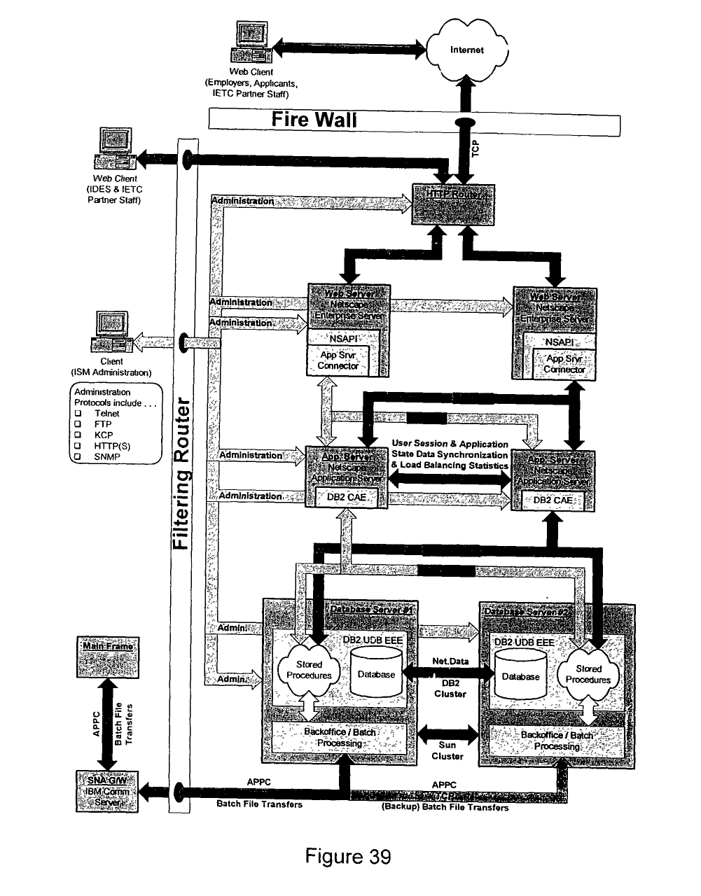

FIG. 39 illustrates the integration of components in the potential positionee/positionor system.

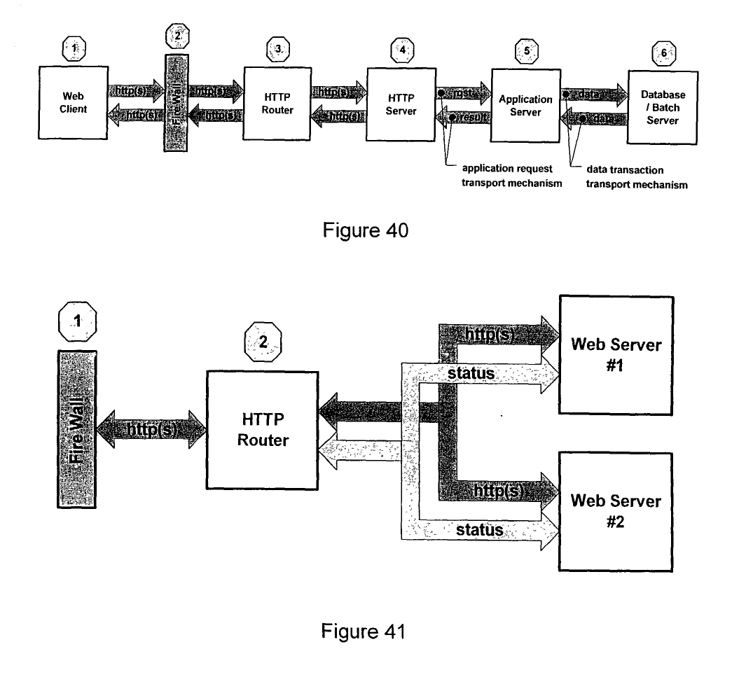

FIG. 40 shows transaction flow in the potential positionee/positionor system.

In step 1 of FIG. 40, the web client requests a resource as specified by a URL. The request is addressed to the IP address obtained from a DNS lookup for a specific host name for the potential positionee/positionor system web presence. The IP address is a virtual IP address associated with the HTTP Router.

In step 2 of FIG. 40, the request reaches the Firewall. The Firewall is configured to pass only packets addressed to the HTTP Router's virtual IP address and only to ports 80 (HTTP) and 443 (HTTPS). All other traffic is blocked by the Firewall. The Firewall passes suitable packets to the HTTP Router.

In step 3 of FIG. 40, the HTTP Router receives the requests passed on by the Firewall. The HTTP Router selects a web server based on current web server loads and which web servers are suitable for responding to the specific URL requested. The HTTP Router passes the HTTP request on to the selected web server.

In step 4 of FIG. 40, the Web Server receives the request passed on by the HTTP Router. The Web Server locates the requested resource. If the resource is static content, then the Web Server retrieves the contents of the resource and sends it back to the client as an HTTP response. If the request is for dynamic content then the web server forwards the request to an Application Server. The Web Server selects an Application Server based on current server loads and on which Application Servers are suitable for responding to the specific content requested. The Web Server passes the request on to the selected Application Server.

In step 5 of FIG. 40, the Application Server receives the request passed on by the Web Server. The Application Server determines which logic module is being requested and invokes it. The logic module may need to access and/or manipulate the database. The module will perform data requests against the Database Server. Data retrieved from the Database Server is used to construct the response.

In step 6 of FIG. 40, the Database Server will receive the database transactions from the Application Server. The transactions will be used to invoke and execute queries and stored procedures.

HTTP Router

Ideally, the potential positionee/positionor system should use multiple web servers to accommodate the volume of activity. The challenge of using multiple web servers is in addressing them and in achieving some degree of load balancing. To solve these problems, a device to route HTTP requests among the available web servers can be used. FIG. 41 illustrates how this HTTP Router interacts with other components within the potential positionee/positionor technical environment.

The HTTP Router monitors the available web servers to which it is allowed to route traffic in order to determine the availability of the servers—such as if they are up or down and the amount of load currently on the servers. As new HTTP requests are received from the Internet, the HTTP Router determines which web server to route the message to based on criteria including which servers are available, which servers are least heavily used, and which servers are capable of handling the request for the specific resource. Not all web servers may have all the content. The system may be designed to allow only certain content to be served by only specific web servers.

Each web server has a different IP address. This creates a problem in terms of the URL that the user uses to request resources. Using this HTTP routing scheme, the HTTP Router has a virtual IP address. All requests from the Internet are addressed to that IP address. The appearance from the outside is that the server at that virtual IP address is handling all of the requests.

The use of multiple web servers with an HTTP Router acting as the “front door” makes the architecture very scalable. Additional web servers can be added at a later time and the configuration of the HTTP Router can be updated to include those new web servers.

The use of this scheme has the built in advantage of providing fail-over capabilities. Should a web server go down, the HTTP Router will detect it and not route further traffic to that server. Any transactions being processed by that specific web server at the time of the failure would themselves fail. Due to the structure of the database transactions, data consistency would not be jeopardized. From the user's perspective, the URL request would time-out. If the user would re-request the resource, by clicking the button or link again, then the request would be resubmitted to the HTTP Router and it would direct it to one of the available servers.

Web Servers

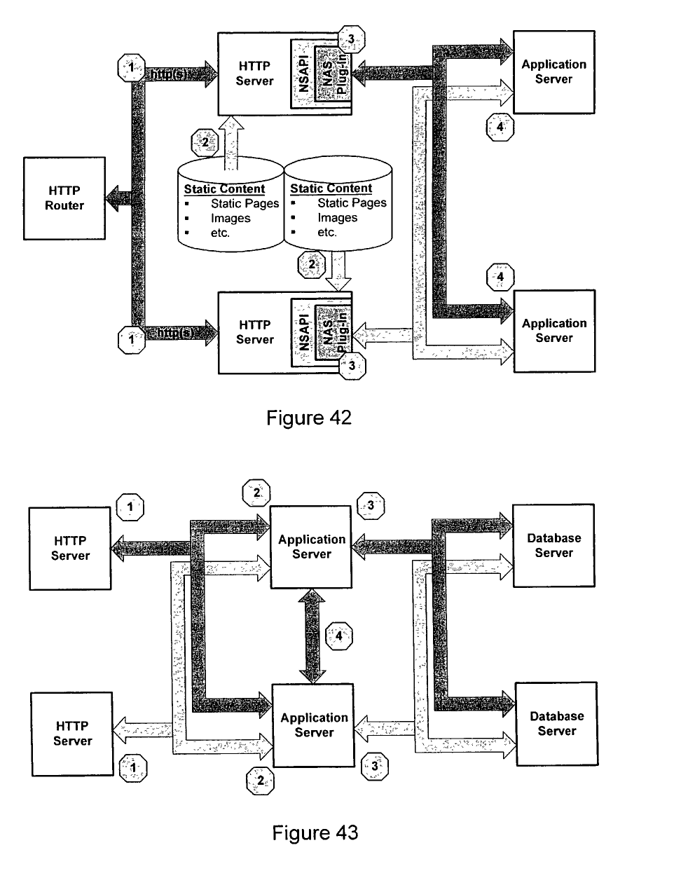

The entire potential positionee/positionor application is run from a web browser. All web page content is delivered to the web browsers by the two web servers. Static (non-changing) content is hosted and served directly by the web servers. In the case of requests for content to be generated dynamically, the web servers pass the request through to the application servers and pass the response back through to the web browsers. FIG. 42 depicts this flow.

At step 1 of FIG. 42, an HTTP request is forwarded on from the HTTP Router to a web server. Each web server is identically configured and has identical capabilities.

At step 2 of FIG. 42, the web server receives the request. If the request is for static content then the web server retrieves the content from the file system and returns it through the HTTP Router.

At step 3 of FIG. 42, if the request is for dynamic content, then the web server forwards the request to the application server plug-in running within the web server. The plug-in and web server interact via the web server's Application Program Interface (API). The plug-in evaluates the request and selects the optimal application server to send the request to. The plug-in then forwards the request to an application server and receives the response. The response is sent back through the web server.

At step 4 of FIG. 42, the plug-in forwards the request to an application server. The application server handles the request, formulates the response, and returns the response to the plug-in.

Ideally, two or more web servers are deployed for the purposes of reliability and performance. Implementing a multi-server solution from the start puts into place the proper infrastructure to scale by adding additional web servers in the future with very little effort.

On each physical web server host computer there will be two web server processes running. One process will service requests for the HTTP protocol providing non-encrypted communications. The other process will service requests for the HTTPS protocol, HTTP running over SSL, providing encrypted communications.

Application Servers

Although the user interface of the potential positionee/positionor system is through a web browser, the system is a robust business application. The application logic is implemented on the application servers. Any database access requests are initiated by the application servers. FIG. 43 illustrates the interaction between the application servers and other components.

At step 1 of FIG. 43, a request is forwarded on from the HTTP server to an application server. Each web server is capable of determining the optimal application server to send each request to. If an application server becomes non-responsive then the web servers will discontinue forwarding requests to that application server and will send them to the surviving application server instead. Once the application server finishes processing the request, it returns the response back to the web server which sent the request.

At step 2 of FIG. 43, the application server receives the request from the web server and begins processing it. The application server will confirm that it is the optimal server to handle that particular request. If that is confirmed, then the application server proceeds with loading and executing the appropriate application logic and constructing the response. The response is sent back to the web server.

At step 3 of FIG. 43, in the process of handling the request, the application server may employ the services of the database server to retrieve or update persistent data.

At step 4 of FIG. 43, if it determines that another application server is better suited to handle a particular request at that time, then it may forward that request to another application server for processing. Application servers also communicate with each other for purposes of exchanging performance and load balancing information as well as replication user session information.

The application servers are in constant communication with each other to maintain the status of every client's activity. In the event that one application server fails, all of the user sessions with the potential positionee/positionor system would be maintained and carried forward by the remaining server(s).

Like the web servers, implementing two application servers initially provides all of the infrastructure needed to scale performance to higher levels by simply adding an additional application server. Isolating the function of the application server further enhances the ability to improve performance exactly where needed in the future.

Database Servers

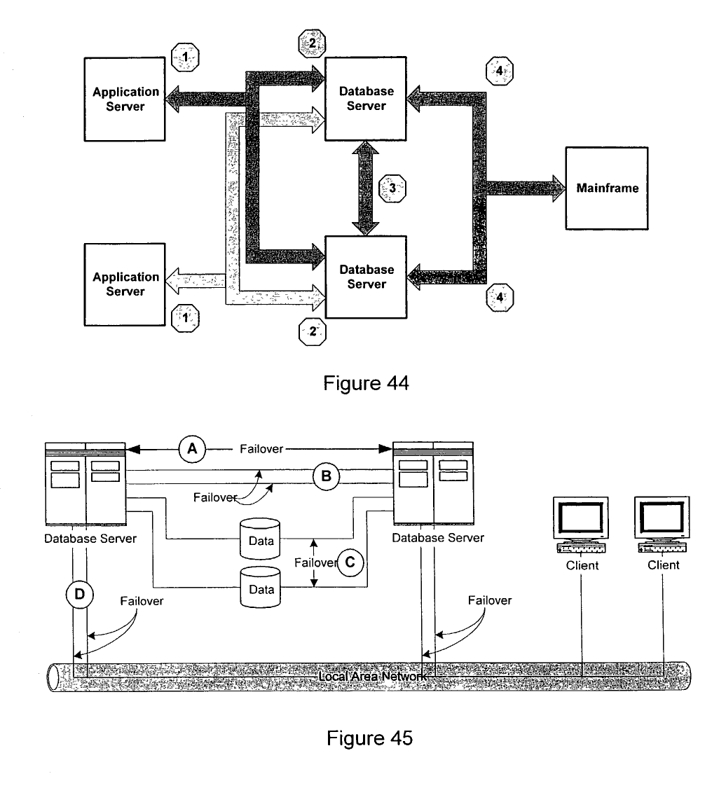

The database servers provide the functionality for the data access layer of the application. Batch processing application components are co-hosted with the database services on the same physical servers. The application servers and the batch processing modules are the “clients” to the database services. The batch processing modules exchange information with legacy mainframe applications via periodic interface exports and imports. FIG. 44 illustrates this interaction between the database servers and the other system components.

At step 1 of FIG. 44, the application servers issue requests for data manipulation to the database servers and receive the data and status back. Both application servers are capable of communicating with either database server.

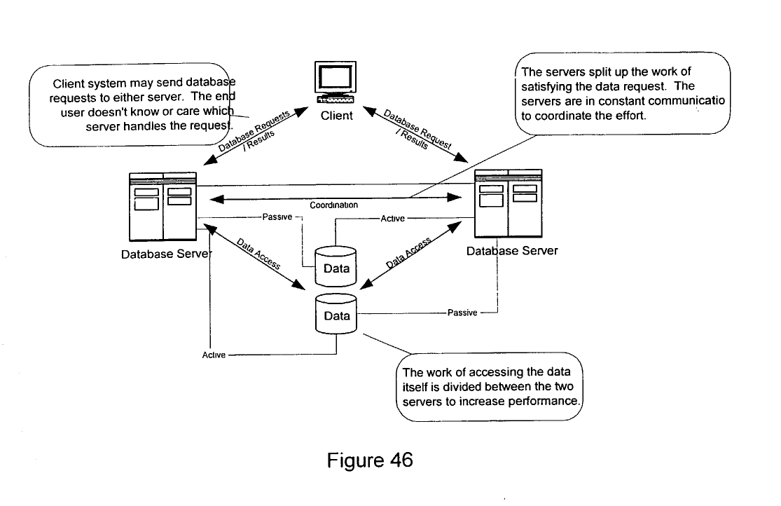

At step 2 of FIG. 46, the database servers handle the data manipulation requests from the application servers and from the batch processing modules running on the same host computers as the database servers are running on.

At step 3 of FIG. 44, the database servers are running within a DB/2 cluster and communicate with each other in order to process queries in parallel and to provide fail-over and a degree of load-balancing. The database servers are also running within a Solaris cluster. The Solaris systems communicate with each other for purposes of fail-over fault-tolerance.

At step 4 of FIG. 44, the batch processing modules exchange information with legacy mainframe applications via periodic interface exports and imports.

Ideally, this system should exhibit 99.9% uptime. Therefore, a highly available parallel database server in the system architecture is desirable. For a database to be highly available, single points of failure must be eliminated. This requires that there be at least two systems combined into a database “cluster”. In addition to having two physical servers, there must be fault tolerance built into the disk subsystem. The database cluster should be able to survive a disk failure. Connectivity between the cluster members must be redundant to eliminate the cluster communications path as a single point of failure. FIG. 45 highlights the major components involved in a highly available database design. FIG. 45 also shows four major areas at which failover can occur to achieve high availability. Each of these potential failure points is described below.

A. Database Software/Cluster Software

When two systems are operating together to produce a highly available database, their software must be equipped to handle faults that may occur. Item A in FIG. 45 represents the software components of the cluster. At the operating system and database software level, the systems are aware of each other and coordinate with each other when necessary. The systems also check on each other's health so that they can react when a problem is detected. If one system determines that the other is unable to continue on for some reason, the operating system and database software coordinate to take on the other's workload.

B. Cluster Interconnect Hardware

Item B in FIG. 45 represents the hardware used to communicate between the cluster members. Cluster systems use a private communication channel. This keeps the excess traffic off of the general network and often makes use of specialized high speed devices for performance purposes. To keep from having a single point of failure, the cluster is designed with redundant private communication channels so that if one device should fail, the other channel can allow communication to continue.

C. Disk Subsystem

Disk subsystems are at the core of any database system. The loss of a disk drive or even a complete disk cabinet should not cause the system to fail. In item C in FIG. 45, both cluster members must have a physical connection to all of the physical disk drives that make up the database so that failover can occur between the systems. The underlying disks also must employ some level of redundancy so that an individual disk drive, controller, or cabinet cannot cause a complete disk subsystem failure. Mirroring or some other level of raid technology is typically employed to achieve this.

D. Network Connection

The database systems must return results back to client systems. Item D in FIG. 45 illustrates the use of dual network interface cards (NICs). If one NIC fails, the system can continue to communicate with its clients through the second NIC.

There are several ways of achieving parallelism in a database. The design for the potential positionee/positionor system benefits from the use of at least two physical servers for high availability. A parallel database is defined as a group of two or more database servers dividing the work of presenting a single logical database to the client. This concept is illustrated in FIG. 46.

In FIG. 46, each server has an active connection to only a subset of the data. The passive connection is available for failover, but is not actively used under normal operating conditions. This is an illustration of a “shared nothing” parallel design. Each system in the database cluster is responsible for a subset of the database.

For a “shared nothing” database to be effective, the data is typically split up between the servers such that half of the users' data is on the disk owned by one system and the other half is connected to the other server. This strategy nets close to twice the performance as a single system. Data access that must access data from both systems is often faster as well. Both systems can collect their portion of the data simultaneously. The system that received the request coordinates collecting the results together to achieve the final result for the client.

The “shared nothing” database design is the most scalable in terms of performance provided the data can be segmented by the user. In one embodiment of the invention, the potential positionee/positionor system design follows this approach.

Physical Architecture

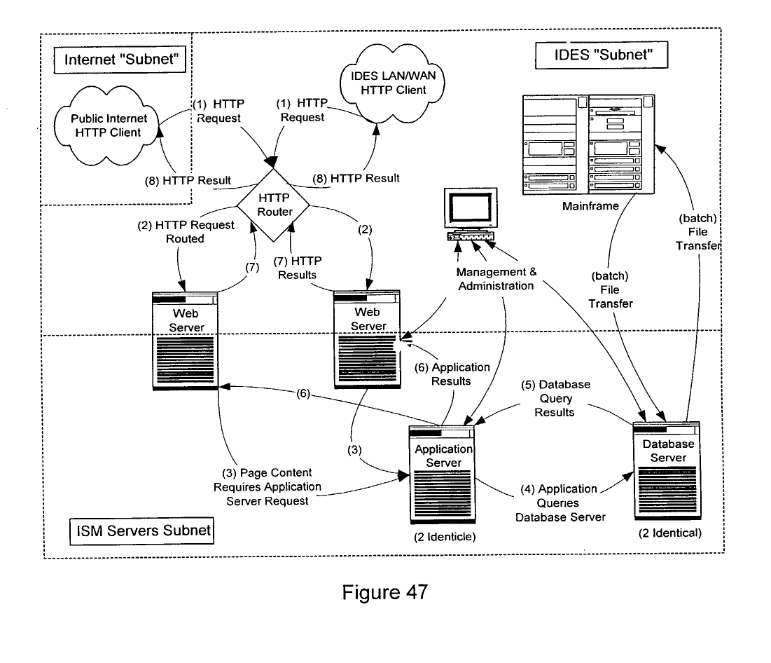

In one embodiment of the invention, the invention's network environment consists of three “subnetworks” as illustrated in FIG. 47. These three subnetworks are: the public Internet, a LAN/WAN environment, and the potential positionee/positionor system.

The Internet zone is defined as the portion of the network that includes a link to the Internet, router, firewall, web and FTP servers. Ideally, this should not include the current connection to the Internet for browsing, etc. from the LAN. Also, the system should ideally have at least 10 Mbs of total bandwidth between it and the Internet. Redundancy in this Internet connection should be implemented at the physical link level and at the firewall. The LAN/WAN zone is defined as a LAN environment as well as a WAN connection to remote offices and partner offices. Ideally, the system should have at least 8 Mbs of total bandwidth to and from remote offices on the WAN. The system zone supports communication between servers for the potential positionee/positionor system. This includes the communication that will occur between the web, application, and database servers. The system zone can be subdivided into two virtual LANs (VLANs). One VLAN contains any systems that a user would need to send a packet to (public VLAN). The other VLAN contains the back end systems that perform database and application logic functions (private VLAN). These systems are never contacted directly by an end user. Only the web server contacts these systems in the context of the potential positionee/positionor application. There is a connection from the private system VLAN to the router to allow management and administration workstations to connect to the system servers.

There are three distinct server types involved in the potential positionee/positionor application: web servers, application servers, and database servers. Providing two of each of these systems in the configuration is ideal for fault tolerance and scalability.

Web Server Physical Architecture

In one embodiment of the invention, Sun Solaris 2.6 servers running on a Sparc-II platform are used for the web servers. This is a solid, proven platform for delivering Internet content. A Netscape Enterprise Server (NES) can be used for the web server software platform of the potential positionee/positionor system. NES provides the necessary features and performance necessary to meet the service level goals of the system. NES integrates seamlessly with the application server platform.

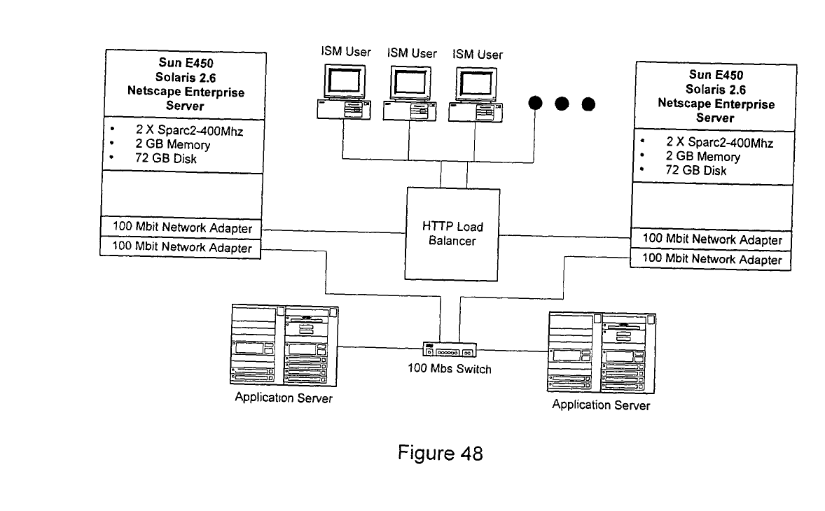

FIG. 48 is a diagram of the web servers and the components they communicate with. There are redundant communication paths from the end users to the dual HTTP routers. From there, the HTTP traffic is load balanced between the two web servers. Redundant network switches ensure a path to at least one of the web servers even in the event of a switch failure.

Application Server Physical Architecture

In one embodiment of the invention, Sun Solaris 2.6 servers running on a Sparc-II platform are used for the application servers. A iPlanet Application Server (iAS) can be used for the application server component of the potential positionee/positionor system.

iPlanet Application Server provides the application logic, transaction management, data access management, load balancing and security services for the potential positionee/positionor system. Ideally, at least two servers will be deployed. The servers coordinate all user session and overall application state data to provide fault tolerance down to the user level. Even if one server went completely down, no users of the system would lose their session with the sytem, or even the state of any current database transactions.

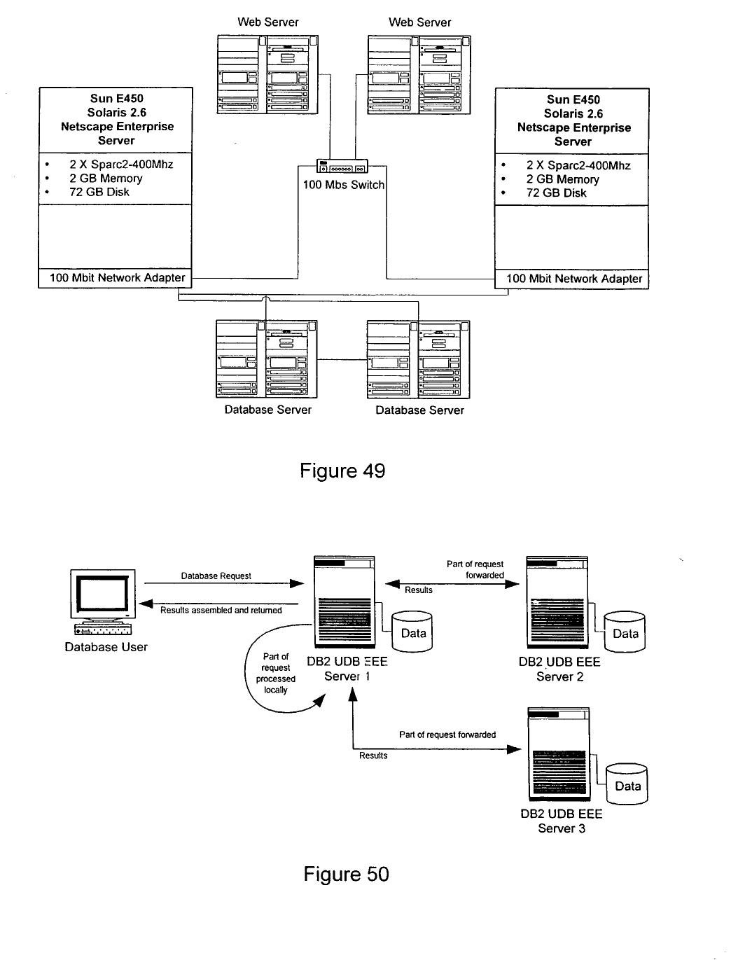

FIG. 49 shows the servers' architecture and interconnection to other components.

Database Server Physical Architecture

In one embodiment of the invention, the IBM DB2 Universal Database Extended Enterprise Edition (UDB EEE) is used for the potential positionee/positionor system's data repository. Sun Solaris 2.6 servers running on a Sparc-II platform using Sun Cluster 2.1 can provide DB2 UDB EEE with the level of performance and reliability the system requires.

DB2 UDB EEE, like many other relational databases, is designed for performance and reliability. Central to these design goals is the use of transaction logging. As modifications are made to the database, a record of each modification is first made in a transaction log. The transaction log will be located in a separate physical area from the rest of the database so that in the event of a database failure, the data can be restored up to the minute by using a previous backup and “replaying” the transaction log. At regular intervals, and at a time when it does not adversely effect performance, transactions are actually committed to the database itself. This technique improves performance since transactions need only be written to the sequential log and updated in memory buffers at the time a transaction commits.

DB2 UDB EEE offers several levels of parallelism. It can take advantage of symetric multiprocessing systems, clustered systems, and a combination of the two. The configuration chosen for the potential positionee/positionor system takes advantage of both techniques.

DB2 UDB EEE is designed to allow multiple physical servers to act as a single logical database. This is accomplished by spreading the data across multiple disks on multiple servers, and taking advantage of the clustering capability of the host operating environment for inter-server communication. Within each server, the database software is capable of dealing with multiple CPUs to divide the workload of multiple clients or complex queries internally.

With DB2 UDB EEE, each server in the cluster can function as both a server and a client. Each server can accept a user database request. If the server has access to all of the data needed, it will satisfy the request by itself. If however some of the data resides on another server, it submits part of the work to itself, and other parts to the other servers for processing in parallel. It then assembles the results from its partners, and returns the complete result to the user client as shown in FIG. 50. FIG. 50 shows three servers as an illustration of scalability. In the case of the potential postionee/positionor system, the “Database User” is actually the iPlanet Application Server.

DB2 UDB EEEs can be fully integrated with Sun Cluster software. Sun Cluster provides the framework that allows DB2 UDB EEE to provide fault tolerance features for the database in the event of a complete system failure. In one embodiment of the invention, the database design for the potential positionee/positionor system uses two database partitions, one running on each server. These partitions are mirrored by Sun Solaris for fault tolerance at the disk drive level.

The DB2 UDB EEE software comes with a cluster aware agent. This agent registers with the Sun cluster software so that it is notified in the event of a failure of one of the cluster's member systems. When this occurs, the agent handles restarting the partition from the failed system on the surviving system.

The two database servers are both physically connected to two drive array cabinets. Under normal operating conditions, each database server performs reads and writes to a separate set of mirrored drives. The mirror sets are split between the two drive cabinets. Within one drive cabinet, one server uses one set of drives and the other uses a different set of drives.

In the event of a disk failure, the Sun Solaris mirroring software will detect the failure and operation will continue to the one good mirror set member. Replacement of the bad disk and rebuilding the mirror can be performed without any downtime. In the event of disk controller failure on either of the systems, failover to the remaining good member of the mirror set will occur. Replacement of the bad controller will involve taking the system down, but the other system can continue providing access to both database partitions. In the event of an entire system failing, the Sun Cluster software steps in and enables the surviving system to take control of the mirror set from the failed system.

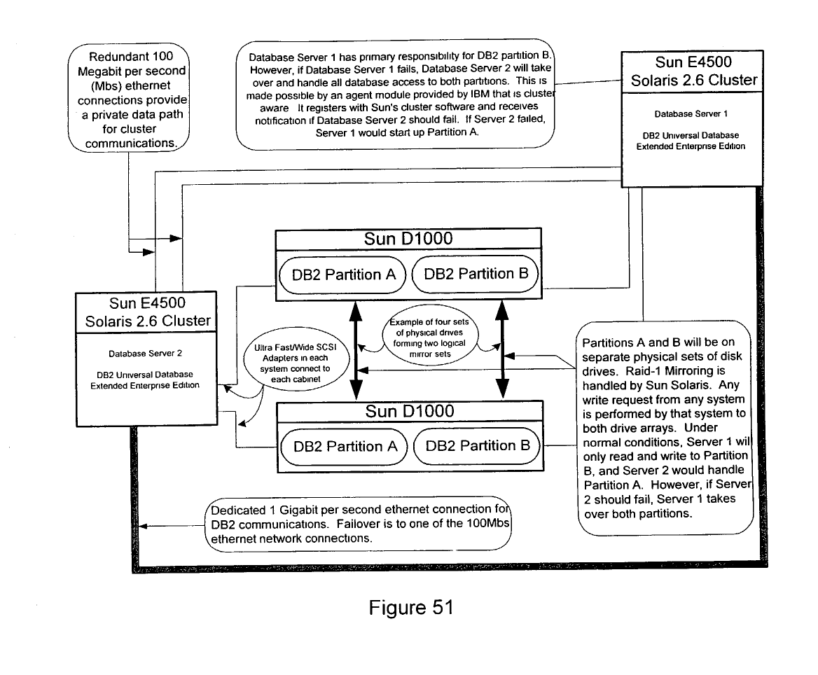

FIG. 51 summarizes the Sun Cluster, mirrored disks, and DB2 UDB EEE's interaction with these components.

Finally, the potential positionee/positionor system should ideally provide tools for configuring each system component as well as real-time status and performance monitoring capabilities.

Infrastructure Architecture

The potential positionee/positionor system infrastructure can be defined as those components that provide core services to the rest of the application components. In one embodiment, much of the infrastructure centers around a iPlanet Application Server.

iAS based applications consist of off-the-shelf iAS servers to provide the core services and custom built application components to implement the application's specific business logic requirements. The custom built application logic components that execute on the server side consist of Java Servlets, Java Server Pages (Java embedded in an HTML document), and application server extensions written in Java and C++.

Servlets and Java Server Pages (JSPs) can use the services provided by the iAS Extensions. The iAS Extensions function much like assembler exit routines on main frame applications. These extensions extend the core capabilities of the base iAS product to provide such functionality as persistent connections to back-end legacy applications, integration with transaction monitors, integration with third party packages, etc.

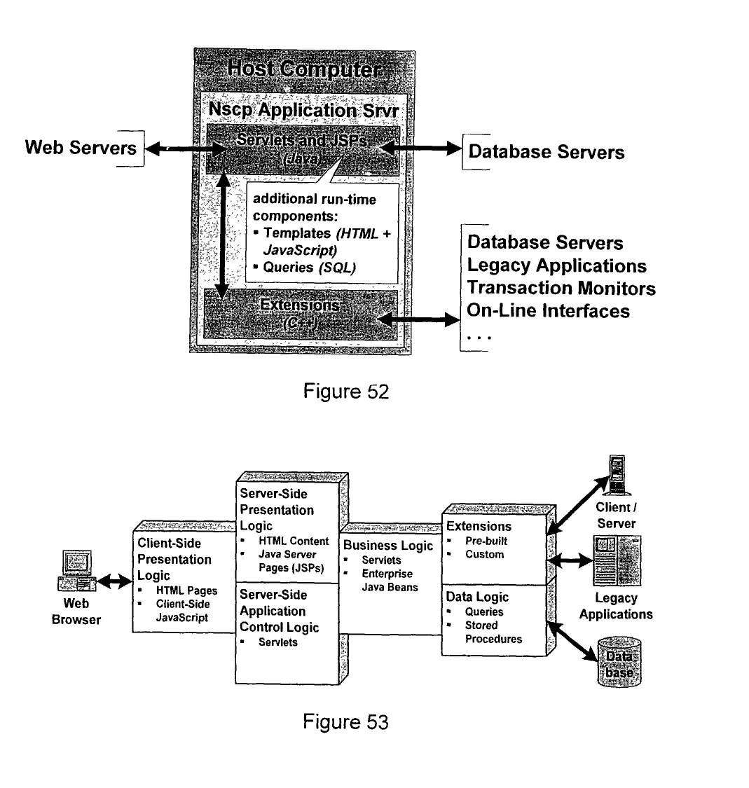

FIG. 52 illustrates at a high-level how the Servlets, JSPs and Extensions work within a iAS server and the points of interaction with the web server, database servers, and other external services.

Structuring the iAS application architecture to use separate components for static pages, dynamic page templates, query files, and executable logic provides a multi-tier application model. A great deal of flexibility is available in matching the best module type to the application module's task. The advantages of this scheme are that the application components are separated into manageable pieces according to the skills required to prepare them and by the functions that they perform. This also allows for greater re-use of components, simpler testing, and modular deployment. This supports a higher quality development result and minimizes the impact on system availability when deploying potential positionee/positionor application software upgrades. FIG. 53 illustrates the tiers of a web application and which iAS and other components address which tier.

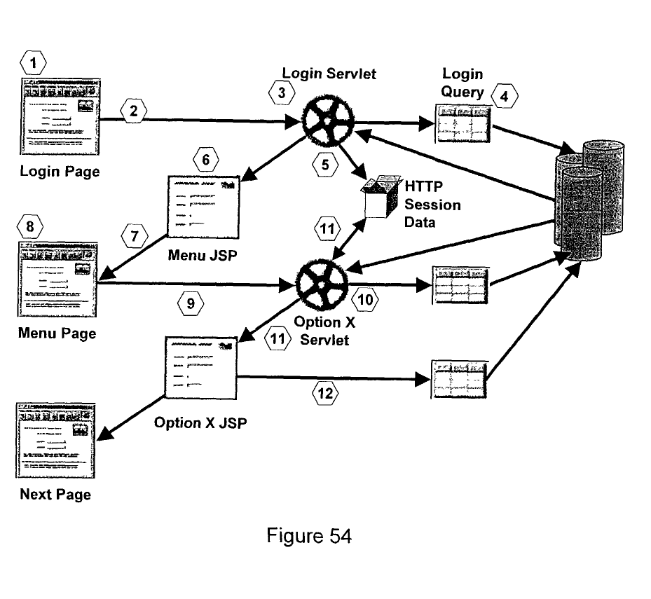

FIG. 54 shows the flow of a iAS based application.

At step 1 of FIG. 54, within a web browser, a user is viewing the “Login” page containing a data entry form. The user enters their user name and password and clicks on the “Login” button.

At step 2 of FIG. 54, the request, containing the values entered onto the web form, is sent through the web server to the application server.

At step 3 of FIG. 54, the application server receives the request and runs the “Login” Servlet.

At step 4 of FIG. 54, the Servlet retrieves the user's user name and password from the incoming parameters and uses the “Login” query to perform a search within the database to verify those credentials and to retrieve information about this user.

At step 5 of FIG. 54, once the credentials have been verified, the Servlet generates a new session identifier and creates a new container (HTTP session object) to hold information pertaining to this user such as the user's user name.

At step 6 of FIG. 54, the Servlet then dispatches to the Menu JSP to generate a menu page customized for that user.

At step 7 of FIG. 54, as the resulting page is created it is sent back to the web browser via the web server. The new session identifier is also sent to the web browser via an HTTP cookie.

At step 8 of FIG. 54, the “Menu” page is received and rendered by the browser. The user can then click on any of the options (links and forms) on that page.

At step 9 of FIG. 54, when the user clicks on an option a new request is sent through the web server to the application server. The web browser also sends the session identifier via an HTTP cookie.

At step 10 of FIG. 54, the application server receives the request and runs the appropriate Servlet.

At step 11 of FIG. 54, the Servlet retrieves all of the incoming parameters, including the session identifier. The Servlet can then use that session identifier to access the existing HTTP session “object” for that user and modify the information contained within it. The Servlet performs any necessary data access and dispatches to the appropriate JSP to prepare the next page for the user.

At step 12 of FIG. 54, optionally, the JSP can make necessary calls to the database to retrieve additional data.

Security Architecture

In one embodiment of the invention, a security architecture provides safeguards to protect, detect, and recover from security breaches. Due to the nature of the public environment and infrastructure, web sites and web-based applications are exposed to several security threats, such as communications eavesdropping, communications tampering, host system breach and authorization violations, denial of service, data and software integrity, and second party repudiation of business transactions.

These security issues can be addressed by this architecture in several ways, including access control, authentication, authorization, confidentiality services, data integrity services, non-repudiation services, intrusion detection, attack recovery, and service protection.

The security architecture can further be broken down into six categories: network safeguards, host server safeguards, Web and FTP server safeguards, application server safeguards, database and batch server safeguards, and system application safeguards.

Network Safeguards

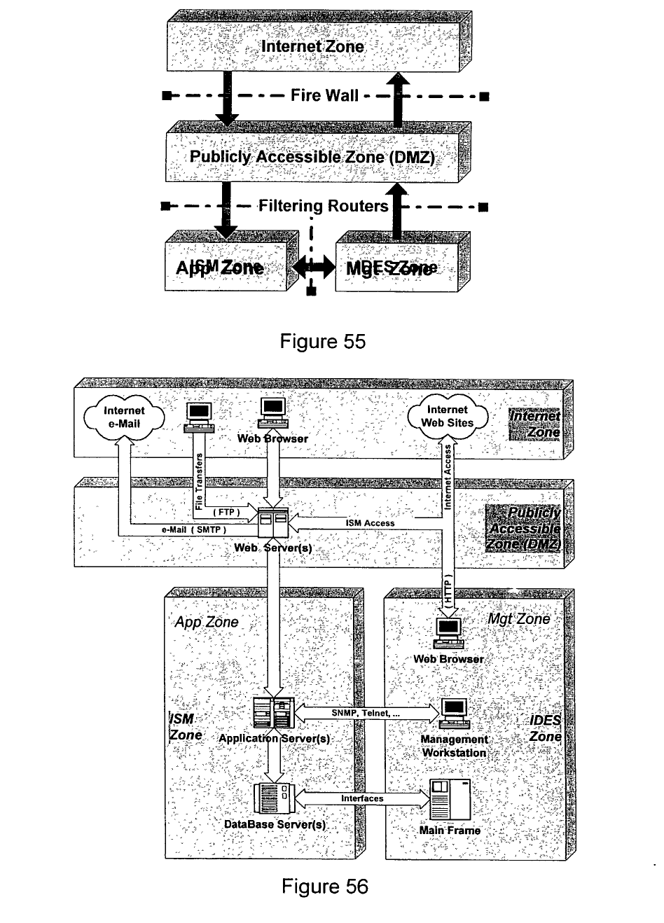

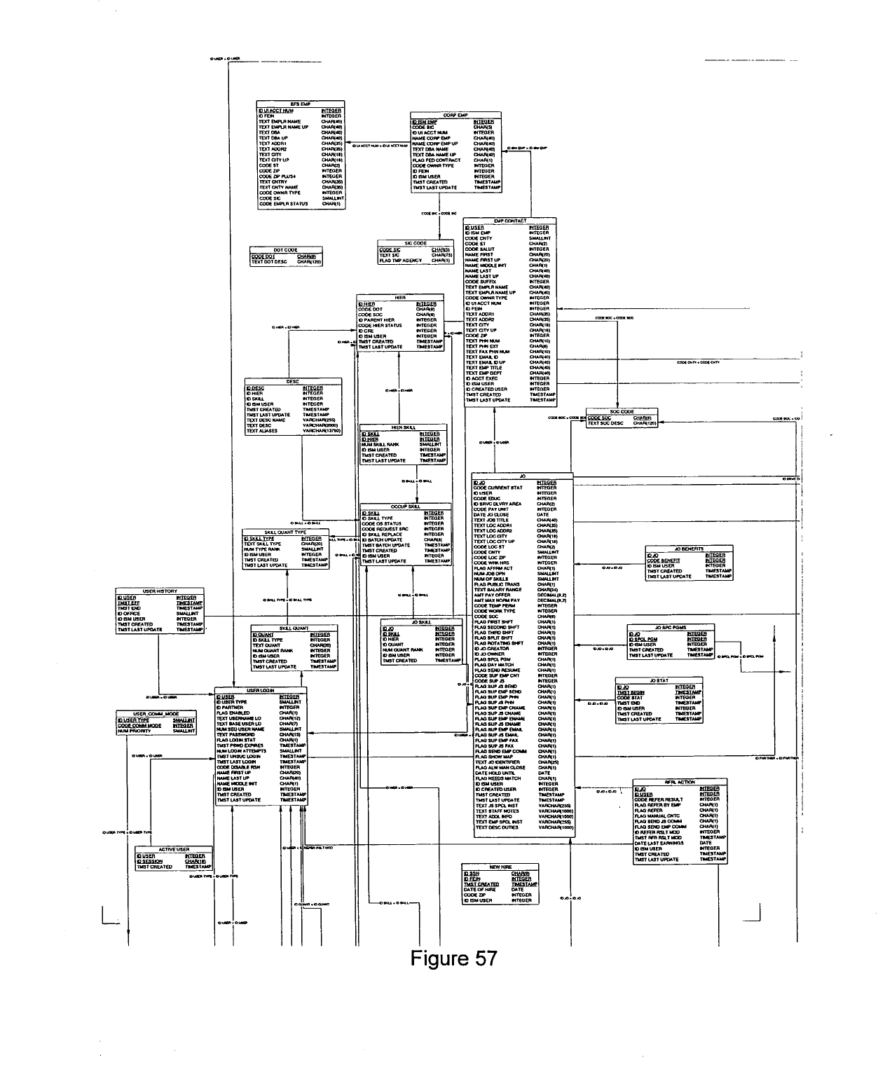

The network architecture has checkpoints at which traffic flow can be denied. This effectively divides the network into sub-networks or zones. FIGS. 55 and 56 illustrate the delineation made between these zones. The Fire Wall provides network packet level access control to the internal network and the servers. The Filtering Router functions much like a fire wall between sub-nets within the network.

The Fire Wall allows the following: Incoming HTTP (web) and FTP (file transfer) traffic to the Web & FTP Servers, and Outgoing SMTP (e-Mail) traffic from the Web & FTP Servers. All other communications will be blocked at the Fire Wall.

The Filtering Router allows the following: Incoming HTTP (web) traffic to the Web & FTP Servers, Incoming and Outgoing traffic between the Database & Batch Servers and the SNA Gateways for purposes of exchanging files for the various interfaces, and Incoming and Outgoing traffic between the Web & FTP, Application, and Database & Batch Servers and various workstations for purposes of system administration and management. Protocols used will include HTTP, SNMP, FTP, Telnet, Netscape Communication Protocol, and RCP. All other traffic will be blocked.

Packet routing authorization is performed based on source IP address, destination IP address, and protocol (as indicated by the destination port number). These items are enforced by the IP protocol and are fundamental to packet routing and delivery. If an external intruder tampered with either address in an attempt to evade these safeguards, the packet would either become undeliverable or any result would not be deliverable back to the intruder.

In one embodiment of the invention, a fire wall consisting of CheckPoint-1 fire wall software running on a Solaris 2.5 operating system running on a Sun Sparc 5 Workstation will be used. This fire wall is well sized for the potential positionee/positionor system. Control and configuration of the Fire Wall is controlled through user authentication, authorization, and access control. User authentication is done via user IDs and passwords which are stored in a standalone, self contained user database on the fire wall host computer. Access to control and configure the fire wall is restricted to only those identified and authorized users. The fire wall host computer is not used for any other purpose. Control and configuration of the other network components are controlled through user authentication, authorization, and access control enforced by the individual components. Authentication is done via user ID and password.

The term “hardened” with regard to computer security refers to components which do not use commercially available operating systems and provide limited or no interactive login. Basically, these are “black boxes”. In one embodiment of the invention, the potential positionee/positionor system uses hardened network components such as routers and switches for the networking infrastructure. This greatly limits the potential for break-ins and data or configuration corruption for these components.

Use of redundant components provides for higher availability through fail-over in the event of a component failure. The failure might occur through a malicious assault or by “natural causes.”

The networking infrastructure is monitored via the SNMP protocol through automated tools. These same tools allow the potential positionee/positionor system Administrator to control and manage the network components.

Host Server Safeguards

The “servers” consist of (at least) two components: the software application providing the service functionality (software service) and the host computer on which this software runs (host server). Security safeguards are implemented on and by the host servers. These safeguards necessarily provide protection to the applications running on them.

Access to the computer servers on which the software services run is restricted. Methods of access to the host computers include Telnet, FTP, rcp, rlogin, SNMP, and Netscape Communication Protocol (NCP). Authentication is made by user ID and password which are verified against a user database local to each individual host system.

Access control restricts access to system resources such as entries within the file system, use of commands and software, network ports, and other resources. Limiting access to the underlying files and file system that hold the programs and data that support the software services, including the Web, Application, and Database Servers, provides enhanced confidentiality and integrity for those components. This also provides protection for the operating system software and configuration. Interactive logon to the host systems is for support and administration purposes only and is greatly restricted. User passwords are set to expire periodically.

Authentication, authorization, access control, and password policies are enforced by the UNIX operating system. UNIX provides a high degree of security and a fine granularity of control over access permissions assigned by user ID, group membership, resource being accessed, and the type of access allowed. In addition, UNIX is a highly stable and robust operating system with wide support. This provides a stable and reliable environment for the potential positionee/positionor system thus increasing availability.

The operating system, application software, custom potential positionee/positionor application, and supporting configuration and data files are backed up on a daily basis. This provides recover-ability in the event of the loss or corruption of this information through either an assault or as a result of component failure. This helps to ensure availability and integrity.

System activity and access is logged by the operating system and associated utilities. Log file access is restricted to Owner=Read+Write, Group=Read, World=No Access. Log files are rotated daily. Security tools are used to analyze the previous day's logs. The previous month's logs are archived.

The host systems are monitored via the SNMP protocol through automated tools. These same tools allow the potential positionee/positionor system Administrator to control and manage the host systems.

Automated tools monitor key files, including the operating system, configurations, and applications in order to detect unexpected changes. This provides a means to detect intrusions and protect the integrity of the application.

Physical security facilities and policies to protect against fire, smoke, explosions, humidity, dust, earthquake, storms, other natural disasters, vibration, food and drink, and theft and vandalism are beneficial. Adequate ventilation and cooling should also be provided.

The host system configurations employ redundant and hot-swapable components. This helps to ensure availability of services. These measures include: disk mirroring, hot swapable disk, N+1 redundancy of power and cooling modules, hot swapable power and cooling modules, and selective N+1 redundancy of network interfaces. Web and FTP Server Safeguards Access to control and configure the Web & FTP Servers, as well as to retrieve the resources served by them, are restricted.

The following HTTP request methods will be allowed from the Internet:

GET: requests a document or other resource from a specific location

HEAD: functionally like GET, except that the server will reply with only the header information about the resource (such as size, name, author, last date modified, etc.) but won't return the actual content.

POST: allows the client to specify data to be sent to some data-handling program that the server can access. This data is sent in the request body.

Other HTTP request methods such as PUT and DELETE will not be supported. Access control also restricts which resources (URLs) can be requested by a specific request.

Individual users are tracked by the potential positionee/positionor application and not by the Web Server. However, the Web Server restricts access to resources based on identification of the requesting client computer. This is done to identify users attempting to access the potential positionee/positionor system from “privileged” workstations. Staff functions are supported by the potential positionee/positionor system only if the user is authenticated as “STAFF” by the potential positionee/positionor application and if they access the system from a “privileged” workstation. These workstations are identified by the Web Server as having either an internal IP address or by presenting a valid and trusted X.509 digital certificate. Anonymous FTP access is disabled.

Access to control and configure the Web and FTP Servers is controlled through mechanisms separate from the authentication and access control for web content.

Requests and responses carrying sensitive or critical data are sent using HTTP over SSL (HTTPS) using encryption and integrity checking. This provides confidentiality, ensures the integrity of the communication, and provides the user with independent certification of the web site identity. This protects against assault schemes such as “man-in-the-middle” and “transaction replay”. Web Browsers supporting SSL are readily available via free download from the Web Browser vendors, or at low cost through retail channels. Web Browsers that do not support SSL are not allowed to access or transmit sensitive content.

The Web Servers are monitored via the SNMP protocol through automated tools. These same tools allow the potential positionee/positionor system Administrator to control and manage the Web Servers.

Web Server access and errors are logged by the Web Servers. Log file access is restricted to Owner=Read+Write, Group=Read, World=No Access. Log files are rotated daily. Security tools are used to analyze the previous day's logs. The previous month's logs are archived.

The Web service processes run under non-privileged user accounts on the host server. They have restricted access to the file system thus restricting which files they can access and modify. This is particularly important since the Web Servers are used to retrieve files from the host system and can be used to invoke programs on the host system.

The Web and FTP Servers are configured to serve content out of mutually exclusive directories. There is no overlap between the directories used by the Web Servers, FTP Servers, and the underlying operating system. This restricts these services from allowing “back door” access to read or modify key files.

CGI program execution on the Web Servers can be disabled except as required for interaction with the Application Server to limit the ability of an intruder to introduce and execute their own program via the Web Server.

When an HTTP request is made for a resource directory without specifying a specific file, the Web Server looks within that directory for a document named “index.htm*” or “home.htm*”. If such a document is found then it is returned in the HTTP response. If no such document is found then the Web Server can be configured to create a directory listing page. This feature is disabled. This prevents a web user from perusing through directories.

Ideally, the host system on which the Web and FTP Servers run is used exclusively for the purpose of hosting these services. No other application software should run on these computers and no other users or administrators should have direct access to these computers.

Web Server content is maintained only via protocols which are not permitted through the fire wall. These protocols include Telnet, NFS, rcp, and Netscape Communication Protocol (NCP, a proprietary protocol of the Application Server).

Redundant Web and FTP Servers are used to provide load balancing and fail-over. The TCP Traffic Router directs web traffic to the pool of available servers, routing traffic around servers that are non-responsive.

Application Server Safeguards

Access to control and configure the Application Server is restricted. Authentication is made by user IDs and passwords and is controlled by the Application Server administration services. This same mechanism is used to control deployment of application components to the Application Server. The networking infrastructure prevents direct access from the Internet to the Application Server. Access control to the potential positionee/positionor application is controlled by the application.

The Application Servers are monitored via the SNMP protocol and proprietary protocols through automated tools. These same tools allow the potential positionee/positionor system Administrator to control and manage the Application Servers.

Application Server access and errors as well as application messages are logged by the Application Server. Log file access is restricted to Owner=Read+Write, Group=Read, World=No Access. Log files are rotated daily. Security tools are used to analyze the previous day's logs. The previous month's logs are archived.

The Application Server processes run under non-privileged user accounts on the host server. They have restricted access to the file system thus restricting which files they can access and modify.

Ideally, the host system on which the Application Server runs is used exclusively for the purpose of hosting these services. No other application software should run on these computers and no other users or administrators should have direct access to these computers.

Application Server content is maintained only via protocols which are not permitted through the fire wall. These protocols include FTP, Telnet, rcp, and Netscape Communication Protocol (NCP, a proprietary protocol of the Application Server).

Redundant Application Servers are used to provide load balancing and fail-over. The Application Server software provides this feature.

Database and Batch Server Safeguards

Access to control and configure the Database Server is restricted. Authentication is made by user IDs and passwords and is controlled by the Database Server administration services. This same mechanism is used to control deployment of stored procedures and data definition changes to the Database Server. The networking infrastructure prevents direct access from the Internet to the Application Server.

Access to query and manipulate the data is also restricted. Authentication is made by user IDs and passwords and is controlled by the Database Server administration services. Access to modify data is restricted to being done only through stored procedures. Stored procedures are limited to the rights of the user ID associated with the database connection on which the stored procedure is run. Performing all updates through stored procedures helps to ensure the integrity of data manipulation operations.

The user credentials necessary to establish a connection to the database, and to query and manipulate the data, are completely separate from the user credentials presented by the end users when challenged by the potential positionee/positionor application. This separation of user domains helps to obscure the user IDs that can be used to access the database. Database user IDs are used by the potential positionee/positionor application software on behalf of end users but are not known to, or used by, the end users directly.

The Database Servers are monitored via the SNMP protocol and proprietary protocols through automated tools. These same tools allow potential positionee/positionor system Administrators to control and manage the Database Servers.

Ideally, the host system on which the database and batch Server runs is used exclusively for the purpose of hosting these services. No other application software should run on these computers and no other users or administrators should have direct access to these computers.

Database Server content is maintained only via protocols which are not permitted through the fire wall. These protocols include FTP, Telnet, rcp, and proprietary protocols of the Database Server.

Redundant Database Servers are used to provide load balancing and fail-over. The Database Server software along with the underlying operating system provides this feature.

The identifying credential of users performing data updates is recorded as audit information within the updated database records. Additional audit information such as the date and time of the update are also recorded. Assuming that the user's credentials and the potential positionee/positionor application have not been compromised, the user will not be able to repudiate the transaction.

System Application Safeguards

Access to use the potential positionee/positionor System is restricted. Authentication is made by user IDs and passwords and is controlled by the potential positionee/positionor application software. User IDs and passwords are stored in the database and used to authenticate credentials presented via web forms by end users.

The System recognizes distinct user types including: Employer, Job Seeker, Staff, Application Administrator, and System Administrator. Employers are able to view all of their own data, update most of their own data, and view the public information of Job Seekers. Job Seekers are able to view all of their own data, update most of their own data, and view the public information of Employers. Staff are able to view all information and update most information of all Employers and Job Seekers. Some restrictions apply to support the concept of Account Managers. Application Administrators have the same privileges as Staff but are also able to change the base data of the System including Clusters, Groups, Titles, and Skills as well as various code tables. System Administrators are able to monitor, control, and manage the System but do not have any specific access to view or change application data including Employers, Job Seekers, Job Orders, base data, etc. However, due to the fact that the System Administrators will have access to the data and program files in order to perform maintenance and backups, they will have the resources to directly access those files.

The type of user privileges allowed are determined by the user ID presented by the end user. Staff functions are also restricted in that the end user must be accessing the system from a privileged workstation.

The potential positionee/positionor application is monitored via the SNMP protocol and proprietary protocols through automated tools. These same tools allow the System Administrator to control and manage the application.

Potential positionee/positionor application access and errors are logged by the application. Log file access is restricted to Owner=Read+Write, Group=Read, World=No Access. Log files are rotated daily. Security tools are used to analyze the previous day's logs. The previous month's logs are archived.

Ideally, the host system on which the database and batch Server runs is used exclusively for this purpose. No other application software should run on these computers and no other users or administrators should have access to these computers.

The potential positionee/positionor application is designed to take advantage of the failover and load balancing capabilities of the underlying Application Server, Database Server, and host systems.

Data entry values are validated within the HTML form within the Web Browser and again by the application running within the Application Server. The client-side validation is a convenience to provide quick feedback for common data entry errors and to avoid unnecessary network and system resource consumption. However, HTTP requests can be spoofed, therefore, any input values received via HTTP requests go through server-side validation.

When a user clicks on a web link or otherwise causes the Web Browser to issue an HTTP request, the URL of the previous page is sent in the HTTP request header as the “HTTP Referrer” variable. The potential positionee/positionor application checks this value on each page request to ensure that the user is navigating the system in the proper sequence and has not used other navigation means (such as the Web Browser “back” and “forward” buttons, Web Browser bookmarks, or direct URL entry) to go to pages out of sequence.

There are two HTTP methods for making an HTTP request and including data: POST and GET. The GET method sends the data as a query string appended to the URL which is sent in the request header. The POST method accommodates sending the data within the body of the request. HTML hyper-links can use only the GET method. HTML forms can use either the GET or POST method. With the GET method, the data, possibly including sensitive information, is included on the URL. This presents security concerns such as the visibility of the URL for the current page on the Web Broswer user interface.

The potential positionee/positionor application uses only the POST method for HTML forms submission. For HTML hyper-links, no sensitive information is included in the query string. In some cases, this means using an HTML form with only a single button when an HTML hyper-link would otherwise have been used.

Since the source code of HTML pages and JavaScript sent to a Web Browser can be viewed by the end user, no internal application values are sent in these pages. These values include database record keys, database table and field names, host names and internal IP addresses, and internal user IDs such as for database access.

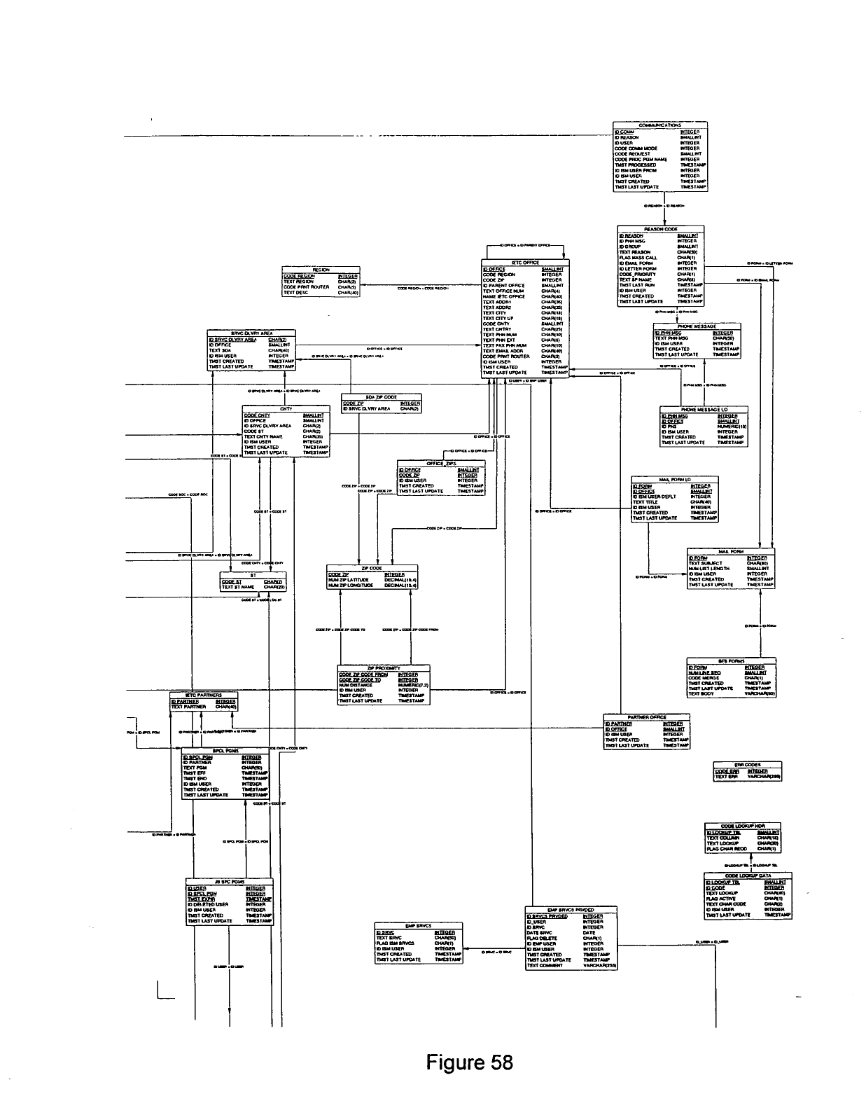

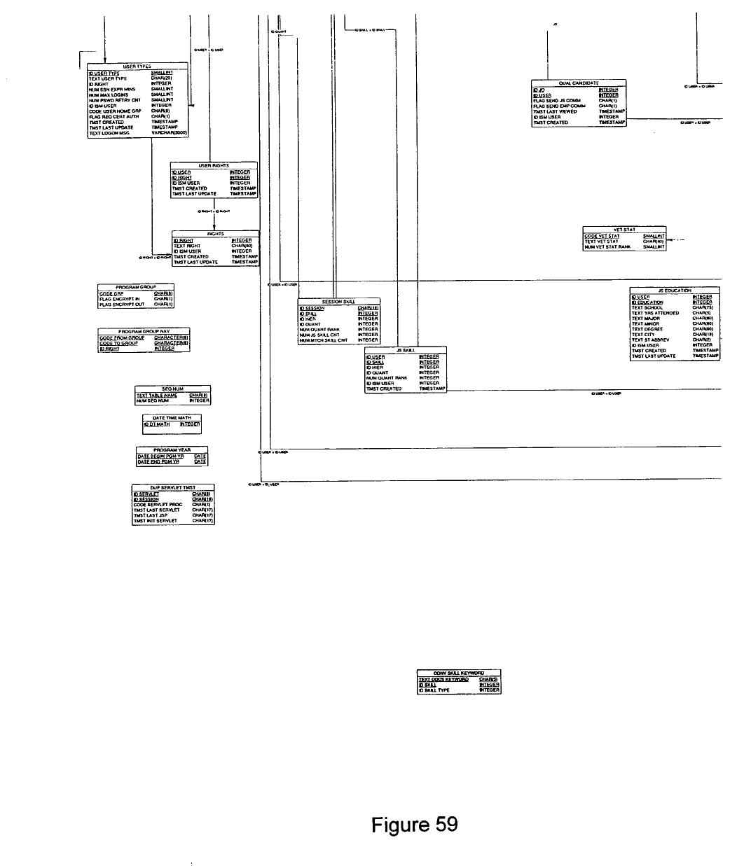

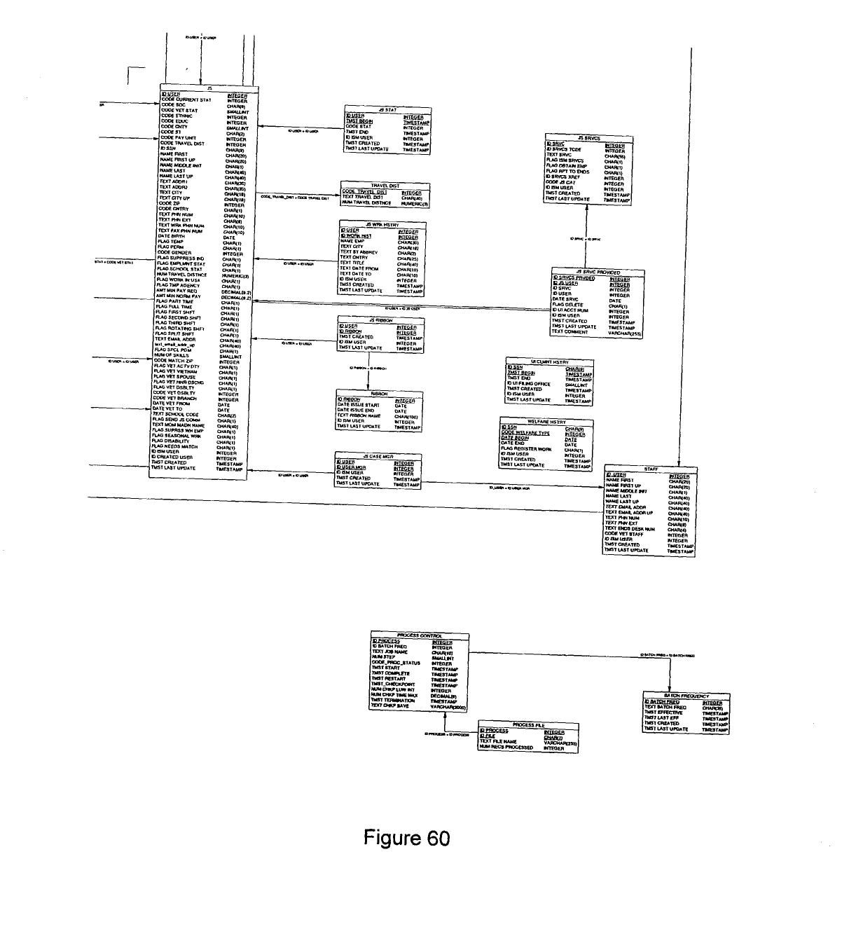

According to one specific embodiment of the invention, FIGS. 57, 58, 59, and 60 represent the potential positionee/positionor system's database. The following tables describe the components of the database:

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

A system according to the present invention has been made available through the World Wide Web with a URL of http://www.illinoisskillsmatch.com, all of which is incorporated by reference herein.

The method and system of the invention has been described with reference to a preferred embodiment suited for jobs; managing the submission of job related information; and matching job seekers to potential employers. It is to be understood that the method and system according to the invention is suitable for other applications involving the matching of groups or members of groups based on various criteria. Such applications include scholarships; group affiliations and memberships; intra-company tasks and assignments; and food service.

While the invention has been described and shown in connection with the preferred embodiment, it is to be understood that modifications may be made without departing from the spirit thereof. The embodiment described is by way of example and should not be construed as limiting of the claims except where referenced to the specification is required for such construction. The claims set forth below are to define the scope of protection sought by this application.

1. A method of matching a potential positionee and a potential positionor, comprising the steps of:
providing the potential positionee with a positionee information entry interface for electronically entering positionee information comprising the potential positionee's actual qualifications, the positionee information being stored in a database;
providing the potential positionor with a positionor information entry interface for electronically entering positionor information comprising at least one target qualification for a position, the positionor information being stored in the database;
determining whether the positionee information correlates with the positionor information;
creating a correlated information list of correlated information; and, providing the correlated information for review.

2. The method of claim 1 wherein the correlated information is provided to the potential positionee for review.

3. The method of claim 1 wherein the correlated information is provided to the potential positionor for review.

4. The method of claim 1 wherein the actual qualifications comprises a skill of the potential positionee.

5. The method of claim 1, wherein the positionee information is maintained confidential.

6. The method of claim 1, wherein the positionee information further comprises contact information for receiving communication.

7. The method of claim 1 wherein the positionee information further comprises veteran information.

8. The method of claim 1 wherein the positionee information further comprises transportation information for position site availability.

9. The method of claim 1 wherein the positionee information further comprises work history information.

10. The method of claim 1 wherein the positionee information further comprises education information.

11. The method of claim 1 wherein the actual qualifications further comprise at least one skill selected from a positionee skills listing.

12. The method of claim 1 wherein the positionee information further comprises at least one position category and the actual qualifications further comprise at least one skill relating to the position category.

13. The method of claim 1 wherein the positionor information further comprises positionor entity information.

14. The method of claim 13 further comprising the step of verifying the existence of the potential positionor using the positionor entity information.

15. The method of claim 1 wherein the positionor information further comprises positionor contact information.

16. The method of claim 1 wherein the positionor information comprises a plurality of target qualifications for the position.

17. The method of claim 1 wherein the positionor information further comprises salary information required for the position.

18. The method of claim 1 wherein the positionor information further comprises benefits information for the position.

19. The method of claim 1 wherein the positionor information further comprises site location information for the position.

20. The method of claim 1 wherein positionor information further comprises a position category.

21. The method of claim 20 wherein the position category comprises at least one skill required for the position.

22. The method of claim 20 wherein the position category comprises at least one skill that would be nice to have, but not required.

23. The method of claim 1 wherein the positionor information comprises special programs participation information.

24. The method of claim 1 wherein the positionor information comprises position posting information for indicating that the position is available.

25. The method of claim 1 wherein the target qualifications further comprise at least one skill selected from a positionor skills listing.

26. The method of claim 1 wherein the target qualifications further comprise at least one skill selected from a positionor skills listing, wherein the actual qualifications further comprise at least one skill selected from a positionee skills listing, and wherein the step of determining whether the positionee information correlates with the positionor information comprises determining whether the at least one skill selected from the positionor skills listing correlates with the at least one skill selected from the positionee skills listing.

27. The method of claim 26 wherein the correlated information comprises only potential positionees for which a correlation has taken place.

28. The method of claim 26 wherein the correlated information comprises only potential positionors for which a correlation has taken place.

29. The method of claim 1 wherein positionee selects one or more skills from a skills listing to identify actual qualifications.

30. The method of claim 29 wherein particular skills can be added and/or deleted to/from the skills listing.

31. The method of claim 1 wherein positionor selects one or more skills from a skills listing to identify target qualifications.

32. The method of claim 31 wherein particular skills can be added and/or deleted to/from the skills listing.

33. The method of claim 1 wherein the positionee information and/or the positionor information can be edited.

34. The method of claim 26 wherein correlation is determined again after any editing of the positionee information or the positionor information.

35. The method of claim 1 wherein the correlated information is rank-ordered according to ranking criteria.

36. The method of claim 1 wherein the correlated information within the correlated information list is rank-ordered according to one or more of the following criteria:
skills that would be nice to have, but not required for the position;
special programs information; and,
veteran information.

37. The method of claim 1 wherein the correlated information list is a trial correlated information list including only the number of correlated potential positionees for a potential positionor, without an identification of the potential positionees.

38. The method of claim 1 further comprising the step of placing an order for a position.

39. The method of claim 1 wherein the correlated information list comprises a list of correlated potential positionors for consideration by one of the potential positionees, wherein the correlated information list further comprises a list of correlated potential positionees for consideration by one of the potential positionors, and wherein the potential positionee can choose to be removed from the correlated information list from which the potential positionor considers such potential positionee.

40. The method of claim 1 wherein at least one step of providing is performed over a computer network, such as a LAN or the Internet.

41. The method of claim 1 wherein the method is performed over a computer network, such as a LAN or the Internet.

42. The method of claim 1 wherein the positionee information is inputted over a computer network, such as a LAN or the Internet.

43. The method of claim 1 wherein the positionor information is inputted over a computer network, such as a LAN or the Internet.

44. The method of claim 1 wherein the correlated information is provided over a computer network, such as a LAN or the Internet.

45. The method of claim 44 wherein the correlated information is provided via e-mail, phone, fax, or letter.

46. The method of claim 1 wherein the positionee information further comprises additional information entered by the potential positionee for indicating any other information relating to the potential positionee which may assist the potential positionor in selection of the potential positionee for the position.

46. The method of claim 1 wherein the positionor information further comprises additional information entered by the potential positionor for indicating any other information relating to the potential positionor which may assist the potential positionee in considering the potential positionor for the position.

47. The method of claim 1 wherein the correlated information list comprises a list of correlated potential positionees for consideration by one of the potential positionors.

48. The method of claim 1 wherein the correlated information list comprises a list of correlated potential positionors for consideration by one of the potential positionees.

49. A method of matching a potential positionor with a potential positionee using a preexisting selection hierarchy comprising the steps of:
selecting a position from a preexisting set of positions; and,
selecting a skill from a preexisting set of skills relating to the selected position.

50. The method of claim 49 further comprising the step of first selecting a field from a preexisting set of fields, wherein the preexisting set of positions relate to the selected field from the preexisting set of fields.

51. The method of claim 49, wherein the preexisting selection hierarchy comprises:
a preexisting set of fields;
preexisting sets of positions, each preexisting set of positions relating to one field within the preexisting set of fields; and,
preexisting sets of skills, each preexisting set of skills relating to at least one position within the preexisting set of positions.

52. The method of claim 51 wherein fields can be added or deleted, wherein positions can be added or deleted, and wherein skills can be added or deleted.

53. The method of claim 49 wherein the preexisting selection hierarchy is stored in electronically readable memory.

54. A computer program for matching a potential positionee and a potential positionor, comprising:
a code segment providing the potential positionee with a positionee information entry interface for electronically entering positionee information comprising the potential positionee's actual qualifications, the positionee information being stored in a database;
a code segment providing the potential positionor with a positionor information entry interface for electronically entering positionor information comprising at least one target qualification for a position, the positionor information being stored in the database;
a code segment for determining whether the positionee information correlates with the positionor information;
a code segment creating a correlated information list of correlated information; and,
a code segment providing the correlated information for review.

55. A method for participation in assisted position placement within special programs comprising the steps of:
providing the potential positionee with a positionee information entry interface for electronically entering positionee information comprising whether the potential positionee qualifies for a special program, the positionee information being stored in a database;
providing the potential positionor with a positionor information entry interface for electronically entering positionor information comprising whether the potential positionor is participating in the special program, the positionor information being stored in the database;
determining whether the positionee information correlates with the positionor information;
creating a correlated information list of correlated information; and,
providing the correlated information for review.

56. The method of claim 55 wherein the positionor information comprises whether the potential positionor is participating in one or more of the following special programs:
(a) DOC 7-B;
(b) MANG;
(c) TANF;
(d) WOTC;
(e) HTF;
(f) NAFS;
(g) Title I;
(h) International Registry:
(i) Sr. Comm. Service Employment Program; and
(j) Title II.
